(19) United States
(12) Patent Application Publication
(10) Pub. No.: US 2015/0160158 A1
(43) Pub. Date: Jun. 11, 2015

(54) ELECTROPHORESIS INSTRUMENT, ELECTROPHORESIS DEVICE, SAMPLE INTRODUCTION METHOD, AND SAMPLE SEPARATION METHOD

(71) Applicant: Sharp Kabushiki Kaisha, Osaka-shi, Osaka (JP)

(72) Inventors: Uichi Midorikawa, Osaka-shi (JP); Hideki Kinoshita, Osaka-shi (JP); Yutaka Unuma, Osaka-shi (JP); Yuji Maruo, Osaka-shi (JP)

(21) Appl. No.: 14/410,688

(22) PCT Filed: Jun. 27, 2013
(86) PCT No.: PCT/JP2013/067617

§ 371 Date: Dec. 23, 2014

(30) Foreign Application Priority Data
Jun. 29, 2012 (JP) 2012-147315
Jun. 29, 2012 (JP) 2012-147689

(51) Int. Cl. G01N 27/447

(52) U.S. Cl. CPC G01N 27/44743; G01N 27/44756

(57) ABSTRACT

There is provided an electrophoresis instrument capable of easily performing a separation of a biological sample by isoelectric focusing with excellent reproducibility.

An electrophoresis instrument (10) includes an electrophoresis chamber (1) in which a sample separation medium (42) for separating the biological sample by electrophoresis is installed. A depression (2) for injecting a sample solution that includes the biological sample is provided on an installation surface (1a) on which the sample separation medium (42) of the electrophoresis chamber (1) is installed.

### TECHNICAL FIELD

The present invention relates to an electrophoresis instrument, an electrophoresis device, a sample introduction method, and a sample separation method which are suitably applicable to two-dimensional electrophoresis for a biological sample in life science technologies.

### BACKGROUND ART

Since two-dimensional electrophoresis generally provides high resolution, two-dimensional electrophoresis is excellent as a method of separating a biological sample, such as proteins. When proteins are separated through two-dimensional electrophoresis, isoelectric focusing is used for separation in a one-dimensional direction. Isoelectric focusing is a method of applying a voltage to a gel and performing separation based on differences in isoelectric points of proteins. In addition, SDS-polyacrylamide gel electrophoresis (SDS-PAGE) using Sodium Dodecyl Sulfate (SDS), which is an anionic surfactant, has been widely used for separation in a two-dimensional direction. In two-dimensional electrophoresis, a large amount of proteins are separated at one time and comprehensive analysis is possible, and thus two-dimensional electrophoresis has been widely used for proteome analysis.

The isoelectric focusing according to the related technology includes two methods, that is, a method of performing the isoelectric focusing by causing a dry strip gel to swell using a swelling agent containing a biological sample and transferring the dry strip gel to a gel strip holder, and a method of performing isoelectric focusing by causing a dry strip gel to swell in advance using only a swelling agent, transferring the dry strip gel to a gel strip holder, and then inserting a biological sample into a sample cup. The latter is called a cup loading method. Since the introduction of the biological sample is performed while the voltage is applied, the efficiency of the introduction of the biological sample is excellent. Since it is possible to introduce the biological sample from a certain area (acidic side or basic side), the latter is used for two-dimensional electrophoresis for a clinical sample or the like as a method in which a migration length is long and resolution is improved (refer to PTL 1).

Generally, in isoelectric focusing using the cup loading method, an aqueous solution, which includes urea, thiourea, 3-[(cholamidopropyl)dimethylammonio]-1-propanesulfonate (CHAPS), dithiothreitol (DTT), and carrier ampholyte is first put into a dedicated chamber, and a dry strip gel (IPG gel) having a fixed pH slope and having been made dry, is immersed into a polyacrylamide gel while causing a gel surface to face downward. The IPG gel swells (rehydrates) in a manner in which a covering solution, such as paraffin oil, for preventing drying is provided, and it is left for several hours.

Subsequently, the IPG gel is removed from the chamber, and wet filter paper and electrodes are installed on the IPG gel while installing the gel surface facing upward in a chamber for isoelectric focusing. Thereafter, a sample cup is installed at an arbitrary position on the gel, a sample solution which includes a biological sample is added to the inside of the sample cup, and covering oil is provided thereto. The covering oil is put on the gel in an area where there is no sample cup such that the gel is not exposed to the air, and thus isoelectric focusing starts after the voltage is applied.

### CITATION LIST

### Patent Literature

PTL 1: Japanese Unexamined Patent Application Publication (Translation of PCT application) No. 2008-510481 (published Apr. 10, 2008)

### SUMMARY OF INVENTION

### Technical Problem

In the isoelectric focusing using the cup loading method, the IPG gel does not uniformly swell even when the swelling agent is dropped on IPG gel which does not have dimensional stability in an IPG gel swelling process, and thus the gel surface generally faces downward. In addition, it is necessary to apply the covering solution onto the biological sample during a process to apply the voltage, and thus it is necessary to cause the gel surface to face upward. Further, it is not possible to install the sample cup without gaps unless the IPG gel is in a swollen state. Due to the above reasons, it is necessary to move the IPG gel after the IPG gel swells.

In addition, as above, since the covering solution (generally, paraffin oil or the like) is necessary to prevent the gel, which includes the biological sample and a lot of moisture, from becoming dry, and the biological sample within the cup is present at a high concentration, a filter (filter paper or the like) for removing impurities deposited between the sample cup and the gap is commonly inserted. The labor for installing the covering solution, the sample cup, the filter, and the like requires skills from a user, and affects the reproducibility of an electrophoresis separation pattern according to a researcher.

From the above background, a method capable of separating a biological sample using isoelectric focusing with excellent reproducibility has been called for.

An object of the present invention is to provide an electrophoresis instrument, an electrophoresis device, a sample introduction method, and a sample separation method which can easily perform the separation of a biological sample using isoelectric focusing with excellent reproducibility.

### Solution to Problem

The present invention provides an electrophoresis instrument including: an electrophoresis chamber that includes an installation surface on which a sample separation medium for separating a biological sample through electrophoresis is installed, and a first electrode and a second electrode that are connected to both ends of the sample separation medium, and a depression for injecting a sample solution that includes the biological sample is formed on the installation surface of the electrophoresis chamber.

The present invention provides a sample introduction method of introducing a biological sample to a sample separation medium for separating the biological sample through electrophoresis, and the method includes: a first step of supplying a sample solution to a sample holding part of an electrophoresis chamber that includes an installation surface on which the sample separation medium is installed, and a first electrode and a second electrode which are connected to both ends of the sample separation medium, and that is provided with the sample holding part which maintains the sample solution while suppressing wet spreading of the sample solution, which includes the biological sample, on the installation surface; and a second step of causing the sample separation medium to come into contact with the sample solution, which has been supplied to the sample holding part, and introducing the biological sample to the sample separation medium.

### Advantageous Effects of Invention

According to the present invention, it is possible to provide an electrophoresis instrument, an electrophoresis device, a sample introduction method, and a sample separation method which can easily perform the separation of the biological sample using isoelectric focusing with excellent reproducibility.

### BRIEF DESCRIPTION OF DRAWINGS

FIG. 1 is a view illustrating the schematic configuration of an electrophoresis device according to a first embodiment.

FIG. 2 is a view illustrating a state in which an IEF chip is installed on the electrophoresis device.

FIG. 3 includes a plan view and a cross-sectional view illustrating an electrophoresis instrument.

FIG. 4 includes explanatory views illustrating a sample introduction method.

FIG. 5 includes explanatory views illustrating the sample introduction method.

FIG. 6 includes a plan view and a cross-sectional view illustrating an electrophoresis instrument according to a second embodiment.

FIG. 7 includes explanatory views illustrating a sample introduction method.

FIG. 8 includes explanatory views illustrating the sample introduction method.

FIG. 9 includes explanatory views illustrating another example of the sample introduction method.

FIG. 10 includes explanatory views illustrating another example of the sample introduction method.

FIG. 11 includes a plan view and a cross-sectional view illustrating an electrophoresis instrument according to a third embodiment.

FIG. 12 includes a plan view and a cross-sectional view illustrating an electrophoresis instrument according to a fourth embodiment.

FIG. 13 includes a plan view and a cross-sectional view illustrating an electrophoresis instrument according to a fifth embodiment.

FIG. 14 includes a view illustrating the pattern of two-dimensional electrophoresis according to an example and a comparative example.

FIG. 15 is a view illustrating the schematic configuration of an electrophoresis device according to a sixth embodiment.

FIG. 16 is a view illustrating a state in which an IEF chip is installed on the electrophoresis device.

FIG. 17 includes a plan view and a cross-sectional view illustrating an electrophoresis instrument.

FIG. 18 includes explanatory views illustrating a sample introduction method.

FIG. 19 includes explanatory views illustrating the sample introduction method.

FIG. 20 includes views illustrating the change in uniformity of a voltage which is applied to a sample separation medium in a case in which a sample separation medium adheres to a sample holding part and a case in which the sample separation medium does not adhere to the sample holding part.

FIG. 21 is a plan view and a cross-sectional view illustrating an electrophoresis instrument according to a seventh embodiment.

FIG. 22 includes explanatory views illustrating a sample introduction method.

FIG. 23 includes explanatory views illustrating the sample introduction method.

FIG. 24 includes views illustrating the change in uniformity of a voltage which is applied to a sample separation medium in a case in which a sample separation medium adheres to a sample holding part and a case in which the sample separation medium does not adhere to the sample holding part.

FIG. 25 includes a plan view and a cross-sectional view illustrating an electrophoresis instrument according to an eighth embodiment.

FIG. 26 includes explanatory views illustrating a sample introduction method.

FIG. 27 includes explanatory views illustrating a sample introduction method.

FIG. 28 includes plan views illustrating an example of another variation of a sample holding part which is installed in the electrophoresis instrument.

### DESCRIPTION OF EMBODIMENTS

### First Embodiment

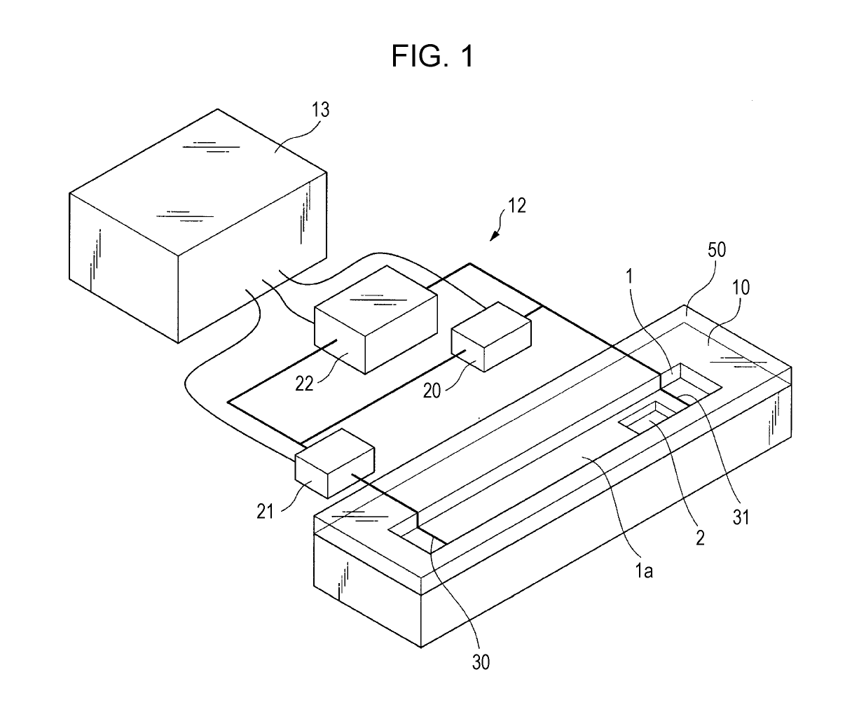

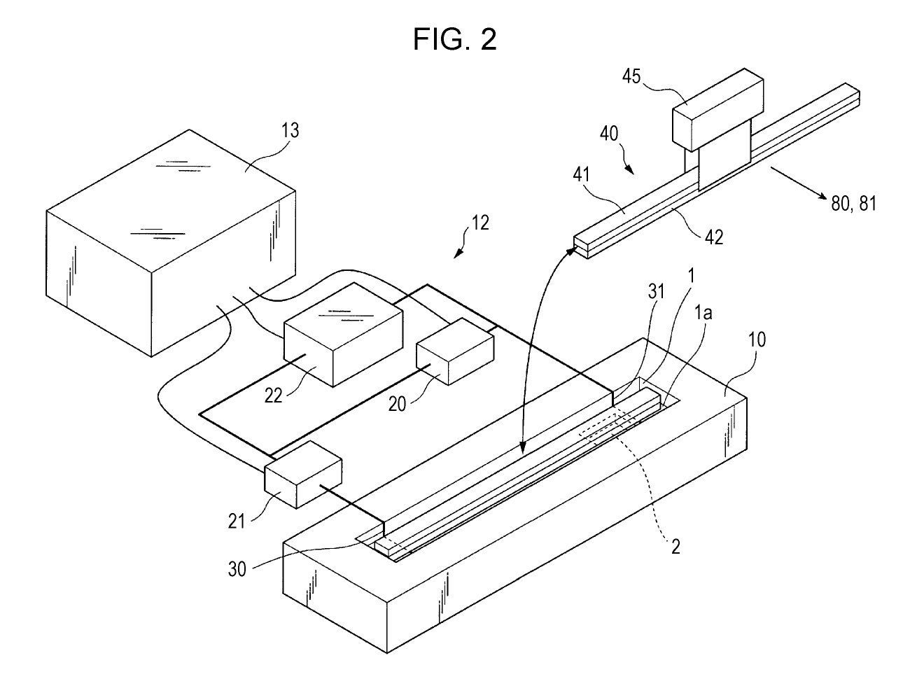

FIG. 1 is a view illustrating a schematic configuration of an electrophoresis device 12 according to a first embodiment. FIG. 2 is a view illustrating a state in which an IsoElectric Focusing (IEF) chip 40 is installed on the electrophoresis device 12.

The electrophoresis device 12 includes an electrophoresis instrument 10, a cover 50, a power supply 22, a voltage measuring device 20, a current measuring device 21, a voltage controller 13 and a conveyance arm 45.

The electrophoresis instrument 10 includes an electrophoresis chamber 1 for installing the IEF chip 40. The electrophoresis chamber 1 is a rectangular-shaped groove which is formed on one surface of the electrophoresis instrument 10, and the bottom surface of the electrophoresis chamber 1 is an installation surface 1a on which the IEF chip 40 is installed. The top of the electrophoresis chamber 1 is covered by the cover 50.

In the electrophoresis chamber 1, a first electrode 30 which is connected to the acidic side end of the IEF chip 40, and a second electrode 31 which is connected to the basic side end of the IEF chip 40 are provided. A depression 2 is provided on the installation surface 1a of the electrophoresis chamber 1 in order to inject a sample solution which includes a biological sample, such as proteins or nucleic acids. The depression 2 is provided between the first electrode 30 and the second electrode 31.

The first electrode 30 and the second electrode 31 are connected to the power supply 22. The power supply 22 is controlled by the voltage controller 13. It is possible to use an ordinary personal computer as the voltage controller 13. The power supply 22 is controlled using a development environment such as Laboratory Virtual Instrumentation Engineering Workbench (Lab VIEW).

The voltage controller 13 sends a signal for applying a designated voltage to the power supply 22. A voltage and a current, which are supplied from the power supply 22 to the first electrode 30 and the second electrode 31, are monitored by the voltage measuring device 20 and the current measuring device 21. The voltage measuring device 21 and the current measuring device 20 detect the voltage and the current, for example, at a frequency of once every 0.1 seconds or higher.

The IEF chip 40 includes a one-dimensional electrophoresis sample separation medium 42, and a support medium 41 which supports the sample separation medium 42. The sample separation medium 42 is a medium which separates a biological sample using isoelectric focusing. It is possible to use a gel, which is usually used as the first dimensional gel in two-dimensional electrophoresis, as the sample separation medium 42. For example, an immobilized pH gradient (IPG) gel or the like, which is gelled by a gelling agent selected from a group consisting of polyacrylamide, agarose, agar, and farina, is suitable. It is possible to use, for example, a plastic plate, a film, or the like as the support medium 41.

The sample separation medium 42 may include a buffer solution. The buffer solution is a solution (solution in which pH does not largely change even when a small amount of acid or base is added or concentration changes a little) having a buffer action for hydrogen ion concentration. A weak acid, a solution, which includes a salt thereof, and the like are representative buffer solutions. It is preferable to use a buffer solution, which does not include polar molecules, as the buffer solution. For example, a buffer solution consisting of 8 M Urea, 2 M Thiourea, 4% CHAPS(3-[(3-Cholamidopropyl)dimethylammonio]propanesulfonate), 20 mM dithiothreitol, and 0.5% Ampholyte is suitable.

The IEF chip 40 is installed in the electrophoresis chamber 1 using the conveyance arm 45, and the introduction of the biological sample and first dimensional electrophoresis (isoelectric focusing) of two-dimensional electrophoresis are performed. In the embodiment, both the introduction of the biological sample and the isoelectric focusing are performed in the electrophoresis chamber 1. However, the introduction of the biological sample may be performed in the electrophoresis chamber 1, and the isoelectric focusing may be performed in another electrophoresis chamber (third electrophoresis chamber 81).

The electrophoresis device 12 is provided with a second electrophoresis chamber 80 for separating the biological sample using second-dimensional electrophoresis (SDS-polyacrylamide gel electrophoresis (SDS-PAGE)). The IEF chip 40 in which the one-dimensional electrophoresis is completed, is conveyed to the second electrophoresis chamber 80 by the conveyance arm 45.

The second electrophoresis chamber 80 includes an installation surface for installing the sample separation medium 42, and a polyacrylamide gel which is a second sample separation medium which is connected to the sample separation medium 42. The second electrophoresis chamber 80 separates the biological sample by applying a voltage to the sample separation medium 42 and the second sample separation medium which are installed on the installation surface. In the electrophoresis chamber 1, the depression is provided on the installation surface at a portion where the sample separation medium 42 is installed. However, in the second electrophoresis chamber, a depression is not provided on the installation surface at a portion where the sample separation medium 42 and the second sample separation medium are installed. It is possible to stably apply a voltage to the sample separation medium 42 and the second sample separation medium by planarizing the installation surface.

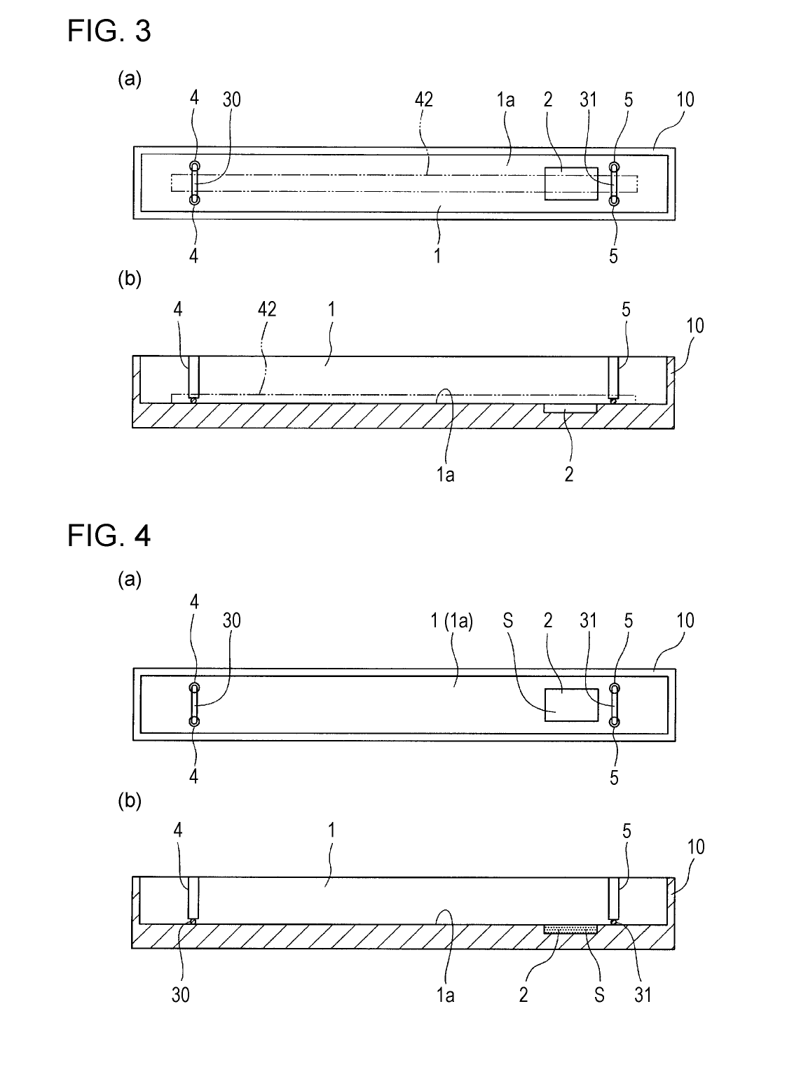

FIG. 3(a) is a plan view illustrating the electrophoresis instrument 10, and FIG. 3(b) is a cross-sectional view illustrating the electrophoresis instrument 10.

The electrophoresis instrument 10 has a cuboid shape, and the electrophoresis chamber 1, which has a long and narrow rectangular shape, is formed at the center of the electrophoresis instrument 10. One end side of the electrophoresis chamber 1 in the longitudinal direction has the first electrode 30 to which the acidic side end of the sample separation medium 42 is connected installed therein, and the other end side of the electrophoresis chamber 1 in the longitudinal direction has the second electrode 31 to which the basic side end of the sample separation medium 42 is connected installed therein.

On one end side and the other end side of the electrophoresis chamber 1 in the longitudinal direction, a first electrode holding part 4 and a second electrode holding part 5 for holding the first electrode 30 and the second electrode 31 are respectively provided. The first electrode holding part 4 and the second electrode holding part 5 are provided to be protruding from the installation surface 1a so as to interpose the acidic side end and the basic side end of the sample separation medium 42 therebetween, respectively.

The depression 2 for injecting the sample solution is formed on the bottom surface (the installation surface 1a on which the IEF chip is installed) of the electrophoresis chamber 1. In the embodiment, the depression 2 is arranged in a position biased to the acidic side or the basic side rather than the center of the electrophoresis chamber 1. However, a position at which the depression 2 is formed is not particularly limited, and, for example, the depression 2 may be formed at the center of the electrophoresis chamber 1.

In a case of the embodiment, the depression 2 is provided on a side which is closer to the second electrode 31 than the first electrode 30. However, the depression 2 may be provided on a side which is closer to the first electrode 30 than the second electrode 31. When the depression 2 is arranged at a position biased to the acidic side or the basic side rather than the center of the electrophoresis chamber 1, the migration length of the biological sample becomes longer when the biological sample is separated using isoelectric focusing, and thus resolution is improved.

It is preferable that the capacity of the depression 2 be slightly smaller than the volume of the sample solution which is injected into the depression 2. According to the configuration, when the sample solution is injected into the depression 2, the sample solution rises from the installation surface 1a, and thus the sample solution reliably comes into contact with the sample separation medium 42. When there is less sample solution, it is preferable that the buffer solution be added to the sample solution such that the depression 2 is filled with the sample solution.

The area of the depression 2 may be an area in which it is possible to acquire a sufficient contact area between the sample solution and the sample separation medium 42, and is not particularly limited. In FIG. 3, the width of the depression 2 is greater than the width of the sample separation medium 42. However, the width of the depression 2 may be smaller than the width of the sample separation medium 42. When the partial or entire width of the depression 2 is wider than the width of the sample separation medium 42, the top of the depression 2 does not become completely covered by the sample separation medium 42, and thus it is easy to discharge bubbles, which are generated when the sample separation medium 42 comes into contact with the sample solution, to the outside of the sample solution.

When the partial or entire width of the depression 2 is wider than the width of the sample separation medium 42, it is preferable that the top of the electrophoresis chamber 1 be covered by the cover 50 in order to prevent drying of the sample solution. When the width of the whole depression 2 is equal to or narrower than the width of the sample separation medium 42, it is not necessary to cover the top of the electrophoresis chamber 1 by the cover 50.

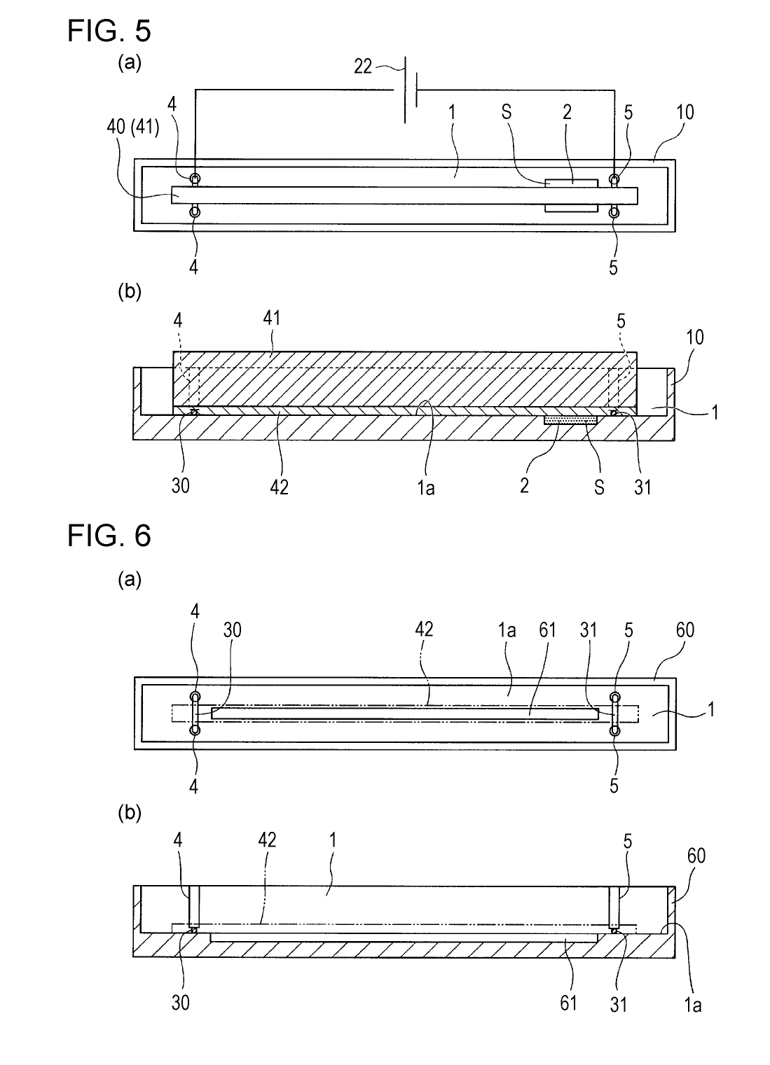

FIGS. 4 and 5 are explanatory views illustrating a sample introduction method of introducing the biological sample to the sample separation medium. FIGS. 4(a) and 5(a) are plan views illustrating the electrophoresis instrument, and FIGS. 4(b) and 5(b) are cross-sectional views illustrating the electrophoresis instrument.

The sample introduction method according to the embodiment is applied to a sample separation method of separating a biological sample using two-dimensional electrophoresis. The sample separation method according to the embodiment includes: a sample introducing step of introducing the biological sample to the sample separation medium 42 using the sample introduction method according to the embodiment, a first electrophoresis step of separating the biological sample using isoelectric focusing by applying a voltage between the first electrode 30 and the second electrode 32, a conveyance step of conveying the sample separation medium 42, acquired by separating the biological sample in the first electrophoresis step, to the second electrophoresis chamber 80, and a second electrophoresis step of applying a voltage to the sample separation medium 42, which is conveyed to the second electrophoresis chamber 80, and separating the biological sample through SDS-polyacrylamide gel electrophoresis (SDS-PAGE).

The sample introduction method according to the embodiment includes a first step of injecting a sample solution S, which includes the biological sample, into the depression 2 of the installation surface 1a on which the sample separation medium 42 is installed, and a second step of causing the sample separation medium 42 to come into contact with the sample solution S, which is injected into the depression 2, and introducing the biological sample to the sample separation medium 42.

More specifically, first, as shown in FIG. 4, the sample solution S, which includes the biological sample, such as proteins or nucleic acids, is injected into the sample solution injection depression 2 which is provided on the installation surface 1a of the electrophoresis chamber 1 and has a depth of approximately 0.5 mm to 1 mm. It is possible to acquire optimum experimental results if the depth of the depression 2 is in a range which is greater than 0 mm and less than 15 mm, and further preferable experimental results can be acquired in a range which is equal to or greater than 0.5 mm and equal to or less than 1 mm. The sample solution S is caused to slightly rise from the installation surface 1a such that the sample solution S reliably comes into contact with the sample separation medium. When the amount of sample solution S is not sufficient, the amount of sample solution S is adjusted by adding the buffer solution such that the depression 2 is filled with the sample solution S.

Subsequently, as shown in FIG. 5, the IEF chip 40, in which the sample separation medium 42 has become saturated and swollen using the buffer solution, is installed in the electrophoresis chamber 1 using the conveyance arm 45 (refer to FIG. 2), the depression 2, into which the sample solution S is injected, is covered by the sample separation medium 42, and the sample separation medium 42 adheres to the depression 2. Further, a voltage of approximately 200 V is applied between the first electrode 30 and the second electrode 31, and thus the biological sample having a charge is introduced to the sample separation medium 42. Thereafter, the voltage rises to 6000 V by pushing the sample separation medium 42 into the depression 2 using the conveyance arm 45 (refer to FIG. 2), and thus isoelectric focusing is performed.

After the isoelectric focusing is performed, the IEF chip 40 is extracted from the electrophoresis chamber 1 using the conveyance arm 45 (refer to FIG. 2). Further, SDS equilibration is performed by immersing the sample separation medium 42 in a solution containing SDS, and the sample separation medium 42 is caused to be connected to a SDS-PAGE sample separation medium (polyacrylamide gel). Further, the IEF chip 40 is conveyed to the second electrophoresis chamber 80 (refer to FIG. 2) by the conveyance arm 45, and thus second-dimensional electrophoresis (SDS-PAGE) is performed.

As described above, in the electrophoresis device 12 according to the embodiment, the sample solution S is supplied to the electrophoresis chamber 1, the sample separation medium 42 is put on the sample solution S, and the introduction of the biological sample is performed. Further, a voltage is applied to the sample separation medium 42 in the electrophoresis chamber 1 without change, and the isoelectric focusing is performed. Since oil for preventing drying, filter paper for removing impurities, or the like is not used when the introduction of the biological sample is performed on the sample separation medium 42, complicated operations are not performed, and thus it is possible to acquire data having high reproducibility.

In addition, in the electrophoresis device 12 according to the embodiment, the introduction of the biological sample is performed while a voltage is applied, and the voltage is applied to the sample separation medium 42 in a state in which the depression 2 is filled with the sample separation medium 42 (a state in which the sample separation medium 42 adheres to the inner wall surfaces and the bottom surface of the depression 2) after the introduction of the biological sample is performed. Therefore, the voltage is uniformly applied to the sample separation medium 42, a sample introduction efficiency is high, and thus uniform focusing and high resolution separation are performed. Accordingly, it is possible to easily perform the separation of the biological sample using isoelectric focusing with excellent reproducibility.

### Second Embodiment

FIG. 6(a) is a plan view illustrating an electrophoresis instrument 60 according to a second embodiment, and FIG. 6(b) is a cross-sectional view illustrating the electrophoresis instrument 60.

The differences between the embodiment and the first embodiment are that a depression 61 for injecting a sample solution is formed in a narrow and long shape from a side which is close to the first electrode 30 to a side which is close to the second electrode 31 while interposing the center of the electrophoresis chamber 1 therebetween, and that the sample separation medium 42, in which the introduction of the biological sample is performed in the electrophoresis chamber 1, is conveyed to the third electrophoresis chamber 81 (refer to FIG. 2), and isoelectric focusing is performed in the third electrophoresis chamber 81.

The length of the depression 61 is slightly shorter than the distance between the first electrode 30 and the second electrode 31. The width of the depression 61 is almost the same as the width of the sample separation medium 42, and the top of the depression 61 is completely covered by the sample separation medium 42. The capacity of the depression 61 is slightly less than the volume of the sample solution which is injected into the depression 61.

The third electrophoresis chamber 81 is an electrophoresis chamber having a flat installation surface on which the sample separation medium 42 is installed. Although the third electrophoresis chamber 81 is different from the electrophoresis chamber 1 in that a depression is not formed on the installation surface, the other configuration is the same as that of the electrophoresis chamber 1. Therefore, the detailed configuration of the third electrophoresis chamber 81 is not shown in the drawing.

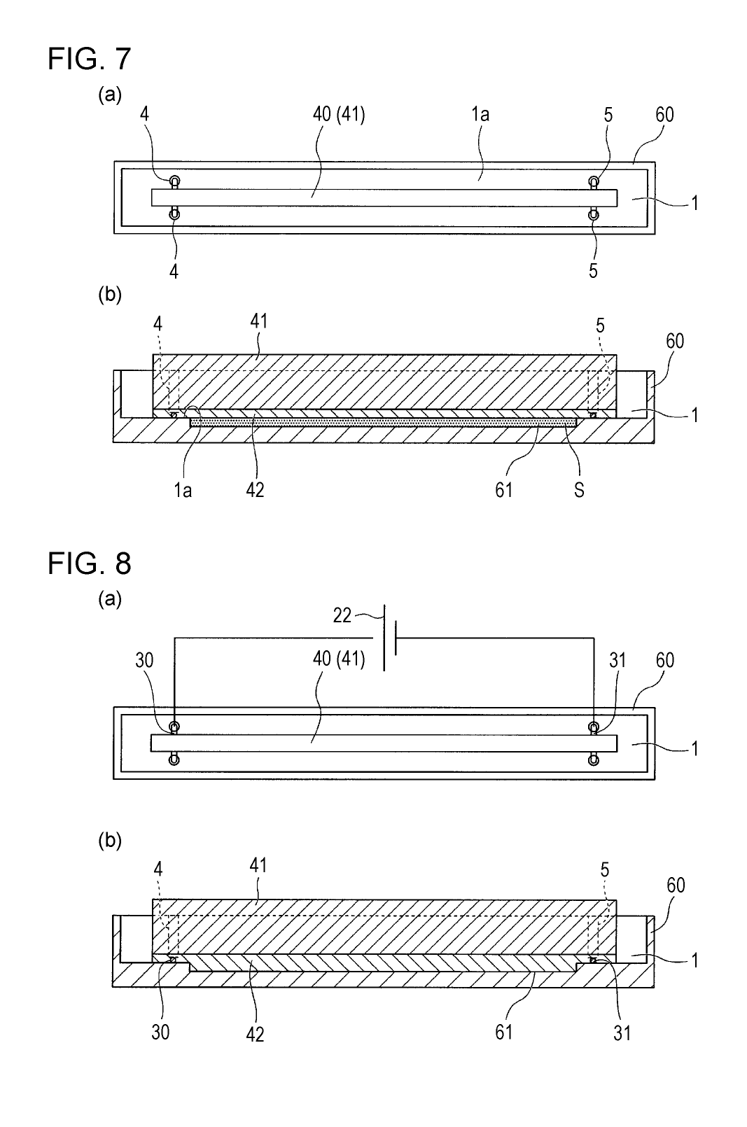

FIGS. 7 and 8 are explanatory views illustrating a sample introduction method of introducing the biological sample to the sample separation medium. FIGS. 7(a) and 8(a) are plan views illustrating the electrophoresis instrument, and FIGS. 7(b) and 8(b) are cross-sectional views illustrating the electrophoresis instrument.

As shown in FIG. 7, the sample solution S which includes the biological sample, such as proteins or nucleic acids, is injected into the sample solution injection depression 61 which is formed on the installation surface 1a of the electrophoresis chamber 1 and has a depth less than 0.5 mm. In the embodiment, a non-saturated and non-swollen sample separation medium, which leaves room for swelling, is used as the sample separation medium 42, unlike the first embodiment.

Subsequently, the IEF chip 40 is installed in the electrophoresis chamber 1 using the conveyance arm 45 (refer to FIG. 2), the depression 2, into which the sample solution S is injected, is covered by the sample separation medium 42, and the sample separation medium 42 adheres to the depression 2. Further, as shown in FIG. 8, a voltage of approximately 200 V is applied between the first electrode 30 and the second electrode 31, and a biological sample having a charge is introduced to the sample separation medium 42. The non-saturated and non-swollen sample separation medium 42 swells further at the same time as the introduction of the biological sample, and the sample separation medium 42 spreads to the bottom of the depression 61. Therefore, a voltage is uniformly applied to the sample separation medium 42, and the biological sample is efficiently introduced to the sample separation medium 42.

Subsequently, the sample separation medium 42 is installed in the third electrophoresis chamber 81 (refer to FIG. 2) using the conveyance arm 45 (refer to FIG. 2). Further, a voltage of 6000 V is applied to the sample separation medium 42 using the first electrode and the second electrode which are provided in the third electrophoresis chamber 81, and thus the separation of the biological sample is performed through isoelectric focusing.

After the isoelectric focusing is performed, the IEF chip 40 is extracted from the third electrophoresis chamber 81 using the conveyance arm 45 (refer to FIG. 2). Further, SDS equilibration is performed by immersing the sample separation medium 42 in a solution containing SDS, and the sample separation medium 42 is caused to be connected to a SDS-PAGE sample separation medium (polyacrylamide gel). Further, the IEF chip 40 is conveyed to the second electrophoresis chamber 80 (refer to FIG. 2) by the conveyance arm 45, and thus second-dimensional electrophoresis (SDS-PAGE) is performed.

In the electrophoresis device according to the above-described embodiment, the depression 61 is formed in a shape elongated in the longitudinal direction of the sample separation medium 42, and thus it is easy for the biological sample to be uniformly introduced to the entire sample separation medium 42. In addition, since the isoelectric focusing is performed using the third electrophoresis chamber 81 which has the flat installation surface, the voltage is uniformly applied to the entire sample separation medium 42, and thus it is possible to perform uniform focusing and high resolution separation.

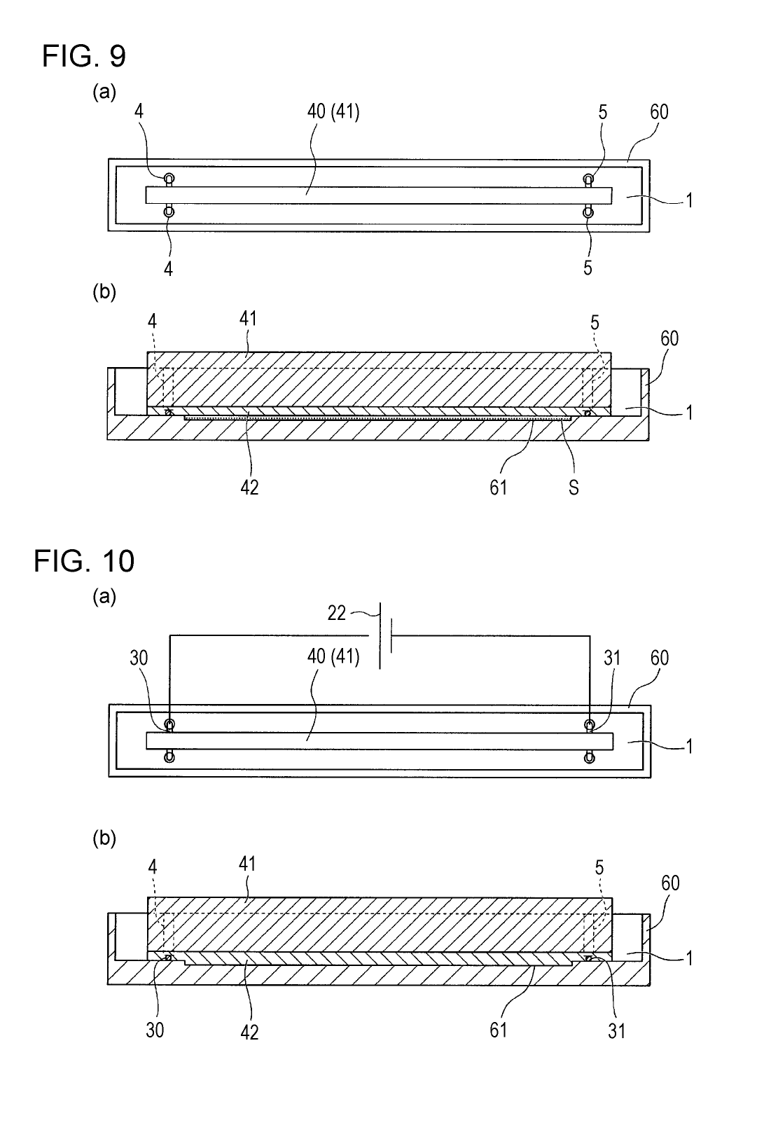

Meanwhile, in the embodiment, the non-saturated and non-swollen sample separation medium is used as the sample separation medium 42. However, as shown in FIG. 9, a sample separation medium, which has become saturated and swollen using the buffer solution, may be used as the sample separation medium 42. In an example of FIG. 9, the depth of the depression 61 is shallower than that in the example of FIG. 7. Even when the saturated and swollen sample separation medium 42 is used, the biological sample is introduced to the sample separation medium 42 by applying a voltage of approximately 200 V to the sample separation medium 42, as shown in FIG. 10.

In the electrophoresis device according to the embodiment, the width of the depression 61 for injecting the sample solution may be wider than the width of the sample separation medium 42. When the partial or entire width of the depression 61 is wider than the width of the sample separation medium 42, the top of the depression 61 is not completely covered by the sample separation medium 42, and thus it is easy to discharge bubbles, which are generated when the sample separation medium 42 is caused to come into contact with the sample solution, to the outside of the sample solution.

When the partial or entire width of the depression 61 is wider than the width of the sample separation medium 42, it is preferable that the top of the electrophoresis chamber 1 be covered by a cover in order to prevent drying of the sample solution. When the width of the entire depression 61 is equal to or narrower than the width of the sample separation medium 42, it is not necessary to cover the top of the electrophoresis chamber 1 using a cover.

### Third Embodiment

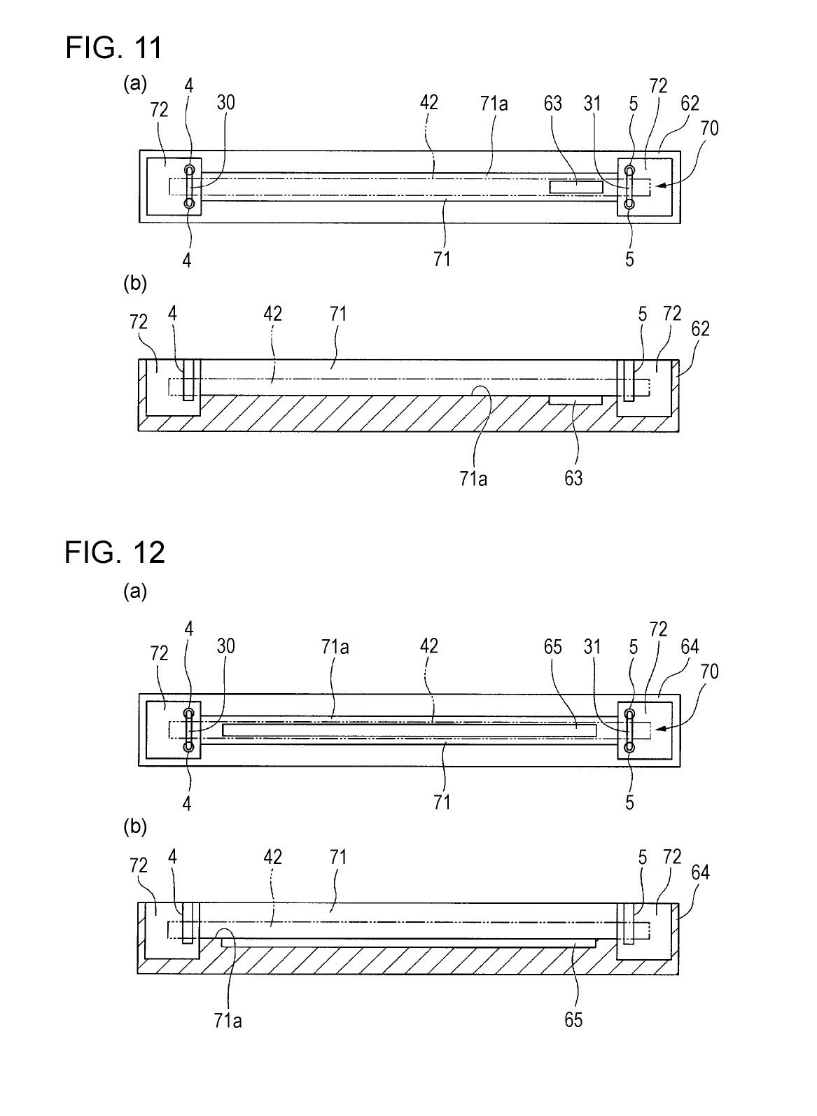

FIG. 11(a) is a plan view illustrating an electrophoresis instrument 62 according to a third embodiment, and FIG. 11(b) is a cross-sectional view illustrating the electrophoresis instrument 62.

The embodiment is different from the first embodiment in that the width of the central part of an electrophoresis chamber 70 narrows to approximately the same width as the sample separation medium 42, and thus drying of the sample separation medium 42 is prevented.

The electrophoresis chamber 70 includes a first part 71 having a width which is approximately the same as the width of the sample separation medium 42, and second parts 72 each having a width which is wider than the width of the sample separation medium 42. The first part 71 has a length which is almost the same as the distance between the first electrode 30 and the second electrode 31, and the second parts 72 are connected to one end side and the other end side of the first part 71 in the longitudinal direction.

The second parts 72 are formed to be deeper than the first part 71, and the first electrode 30, the first electrode holding part 4, the second electrode 31, and the second electrode holding part 5 are installed in the second parts 72. The length of the sample separation medium 42 is slightly longer than the length of the first part 71, and one end side and the other end side of the sample separation medium 42 protrude over the second parts 72 in the longitudinal direction.

A depression 63 for injecting a sample solution is provided on the bottom surface of the first part 71 (installation surface 71a of the sample separation medium 42). The width of the depression 63 is almost the same as the width of the sample separation medium 42, and the top of the depression 63 is completely covered by the sample separation medium 42. The capacity of the depression 63 is slightly less than the volume of the sample solution which is injected into the depression 63.

In the electrophoresis device according to the embodiment, since the first part 71 of the electrophoresis chamber 70 has the same width as that of the sample separation medium 42, the side surfaces of the sample separation medium 42 are covered by the inner walls of the first part 71, and thus drying of the sample separation medium 42 is prevented. Accordingly, it is possible to easily perform the separation of the biological sample with excellent reproducibility.

Meanwhile, in the electrophoresis device according to the embodiment, the width of the depression 63 for injecting the sample solution may be wider than the width of the sample separation medium 42. When the partial or entire width of the depression 63 is wider than the width of the sample separation medium 42, the top of the depression 63 is not completely covered by the sample separation medium 42, and thus it is easy to discharge bubbles, which are generated when the sample separation medium 42 is caused to come into contact with the sample solution, to the outside of the sample solution.

When the partial or entire width of the depression 63 is wider than the width of the sample separation medium 42, it is preferable that the top of the electrophoresis chamber 70 be covered by a cover in order to prevent drying of the sample solution. When the width of the entire depression 63 is equal to or narrower than the width of the sample separation medium 42, it is not necessary to cover the top of the electrophoresis chamber 70 using a cover.

In addition, in the embodiment, only a part of the electrophoresis chamber 70 has approximately the same width as the sample separation medium 42. However, the entire electrophoresis chamber 70 may have approximately the same width as the sample separation medium 42.

### Fourth Embodiment

FIG. 12(a) is a plan view illustrating an electrophoresis instrument 64 according to a fourth embodiment, and FIG. 12(b) is a cross-sectional view illustrating the electrophoresis instrument 64.

The embodiment is different from the third embodiment in that a depression 65 for injecting a sample solution is formed in an elongated shape from a side which is close to the first electrode 30 to a side which is close to the second electrode 31 while interposing the central portion of the electrophoresis chamber 70 therebetween.

The depression 65 is provided on the bottom surface of the first part 71 (the installation surface 71a of the sample separation medium 42). The length of the depression 65 is slightly shorter than the distance between the first electrode 30 and the second electrode 31. The width of the depression 65 is almost the same as the width of the sample separation medium 42, and the top of the depression 65 is completely covered by the sample separation medium 42. The capacity of the depression 65 is slightly less than the volume of the sample solution which is injected into the depression 65.

In the electrophoresis device according to the embodiment, the depression 65 is formed in the shape elongated in the longitudinal direction of the sample separation medium 42, and thus it is easy for the biological sample to be uniformly introduced to the entire sample separation medium 42.

Meanwhile, in the electrophoresis device according to the embodiment, the width of the depression 65 for injecting the sample solution may be wider than the width of the sample separation medium 42. When the partial or entire width of the depression 65 is wider than the width of the sample separation medium 42, the top of the depression 65 is not completely covered by the sample separation medium 42, and thus it is easy to discharge bubbles, which are generated when the sample separation medium 42 comes into contact with the sample solution, to the outside of the sample solution.

When the partial or entire width of the depression 65 is wider than the width of the sample separation medium 42, it is preferable that the top of the electrophoresis chamber 70 be covered by a cover in order to prevent drying of the sample solution. When the width of the entire depression 65 is equal to or narrower than the width of the sample separation medium 42, it is not necessary to cover the top of the electrophoresis chamber 70 by the cover.

### Fifth Embodiment

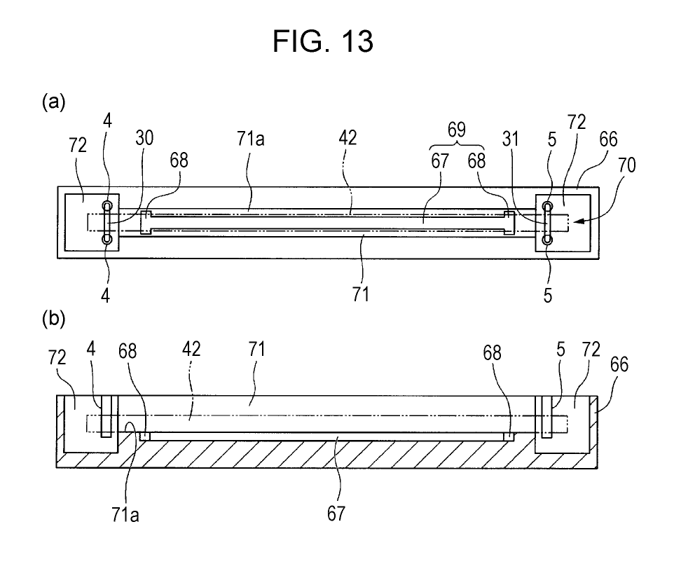

FIG. 13(a) is a plan view illustrating an electrophoresis instrument 66 according to a fifth embodiment, and FIG. 13(b) is a cross-sectional view illustrating the electrophoresis instrument 66.

The embodiment is different from the fourth embodiment in that the width of a depression 69 for injecting a sample solution is partially widened and is exposed on the sides of the sample separation medium 42.

The width of the first part 71 of the electrophoresis chamber 70 is slightly wider than the width of the sample separation medium 42. The depression 69 includes a first part 67 having a width which is almost the same as the width of the sample separation medium 42, and second parts 68 each having a width which is wider than the width of the sample separation medium 42. The first part 67 has a length which is slightly shorter than the length of the first part 71 of the electrophoresis chamber 70, and the second parts 68 are connected to one end side and the other end side of the first part 67 in the longitudinal direction.

In the electrophoresis device according to the embodiment, the top of the first part 67 is completely covered by the sample separation medium 42. However, the top of the second parts 68 may not be completely covered by the sample separation medium 42. Therefore, it is easy to discharge bubbles, which are generated when the sample separation medium 42 comes into contact with the sample solution, to the outside of the sample solution.

### [First Modification]

In the embodiment, the rectangular shape and the I-letter shape are described as the shape of the depression into which the sample solution is injected. However, the shape of the depression is not limited thereto. For example, a depression, which is formed by a curved line such as an ellipse or a circle, or a depression, which has a polygonal shape other than a rectangle, may be formed. In addition, the number of depressions is not limited to one, and it is possible to form a plurality of depressions.

### EXAMPLE

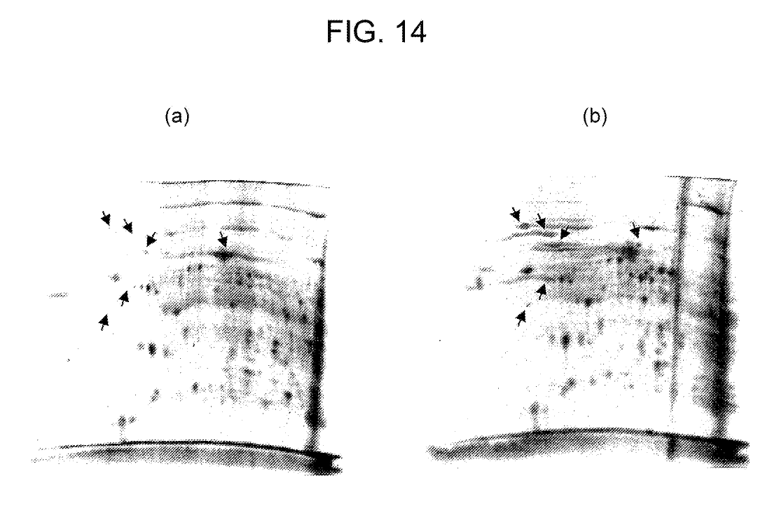

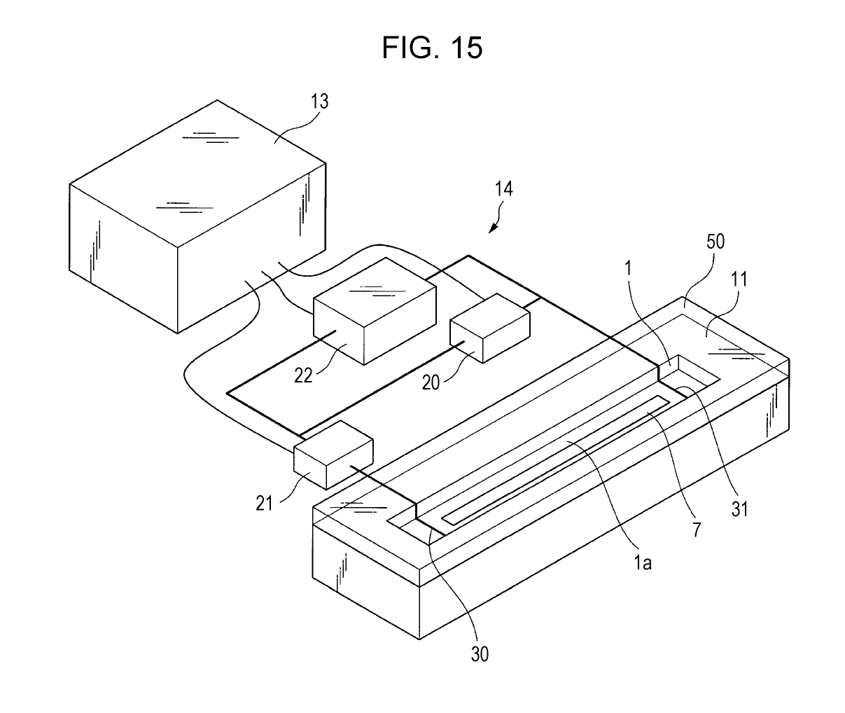

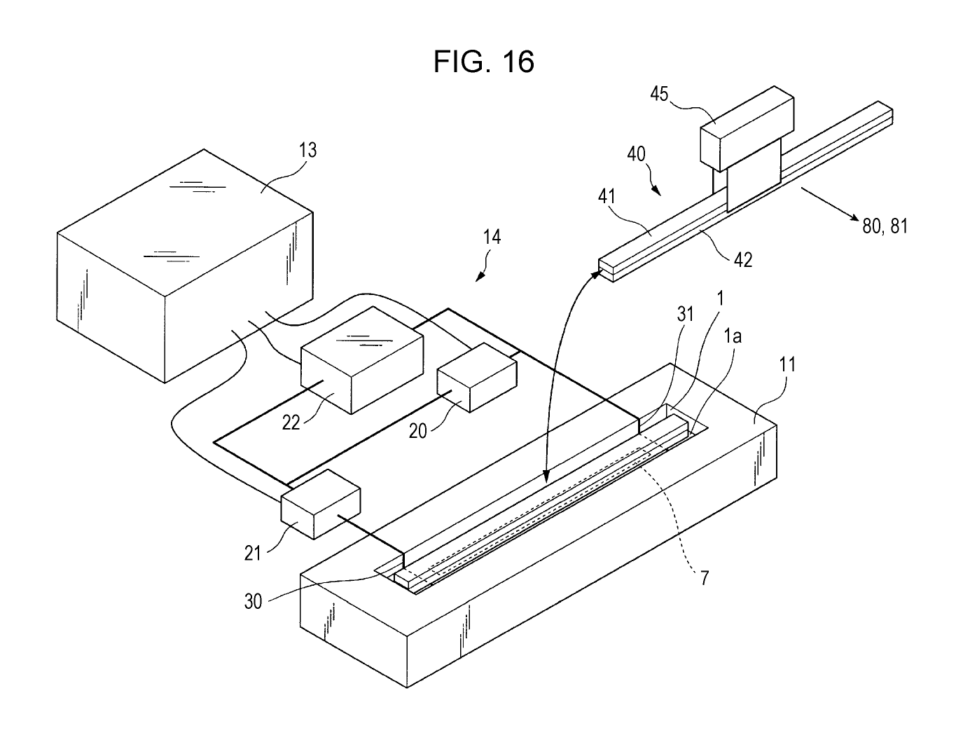

FIG. 14(b) is a view illustrating the pattern (example) of two-dimensional electrophoresis using the electrophoresis device according to the first embodiment. FIG. 14(a) is a view illustrating the pattern (comparative example) of two-dimensional electrophoresis acquired when a biological sample is introduced to a gel strip holder according to the related art. Based on the arrowed spots shown in FIG. 14, the improvement of resolution is seen in the pattern of the two-dimensional electrophoresis shown in FIG. 14(b), and thus it is possible to detect clear spots, compared to the pattern of the two-dimensional electrophoresis shown in FIG. 14(a).

### [Summary of First to Fifth Embodiments]

An electrophoresis instrument according to an aspect of the present invention includes an electrophoresis chamber that includes an installation surface on which a sample separation medium for separating a biological sample through electrophoresis is installed, and a first electrode and a second electrode that are connected to both the ends of the sample separation medium, and a depression is provided on the installation surface of the electrophoresis chamber in order to inject a sample solution including the biological sample.

In addition, in the electrophoresis instrument according to the aspect of the present invention, the depression may be provided on a side which is closer to the first electrode than the second electrode or on a side which is closer to the second electrode than the first electrode.

In addition, in the electrophoresis instrument according to the aspect of the present invention, the depression may be formed from a side which is close to the first electrode to a side which is close to the second electrode while interposing the central part of the electrophoresis chamber therebetween.

In addition, in the electrophoresis instrument according to the aspect of the present invention, a capacity of the depression may be less than a volume of the sample solution which is injected into the depression.

In addition, in the electrophoresis instrument according to the aspect of the present invention, the sample separation medium may be a swollen gel.

In addition, in the electrophoresis instrument according to the aspect of the present invention, at least a part of the electrophoresis chamber may be formed to have approximately the same width as the sample separation medium.

In addition, in the electrophoresis instrument according to the aspect of the present invention, at least a part of the depression may be formed to have a wider width than the sample separation medium.

An electrophoresis device according to an aspect of the present invention includes the electrophoresis instrument according to the present invention, and a conveyance arm that installs the sample separation medium in the electrophoresis chamber.

In addition, the electrophoresis instrument according to the aspect of the present invention may further include a second electrophoresis chamber in which the sample separation medium is installed, and the conveyance arm may convey the sample separation medium between the electrophoresis chamber and the second electrophoresis chamber.

In addition, the electrophoresis instrument according to the aspect of the present invention may further include a third electrophoresis chamber that has a flat installation surface, on which the sample separation medium is installed, and the first electrode and the second electrode which are connected to both the ends of the sample separation medium, and the conveyance arm may convey the sample separation medium between the third electrophoresis chamber and the second electrophoresis chamber.

A sample introduction method according to an aspect of the present invention is a sample introduction method of introducing a biological sample to a sample separation medium that separates the biological sample through electrophoresis, and the method includes: a first step of injecting a sample solution including the biological sample into a depression on an installation surface of an electrophoresis chamber that includes the installation surface on which the sample separation medium is installed, a first electrode and a second electrode that are connected to both the ends of the sample separation medium, and the depression which is installed on the installation surface; and a second step of causing the sample separation medium to come into contact with the sample solution injected into the depression, and introducing the biological sample to the sample separation medium.

In addition, in the sample introduction method according to the aspect of the present invention, the second step may include causing the sample solution to come into contact with the sample separation medium while applying a voltage between the first electrode and the second electrode.

A sample separation method according to an aspect of the present invention includes a sample introducing step of introducing a biological sample to a sample separation medium using the sample introduction method of the present invention; and a first electrophoresis step of applying a voltage between the first electrode and the second electrode, and separating the biological sample through isoelectric focusing.

In addition, the sample separation method according to the aspect of the present invention may further include a conveyance step of conveying the sample separation medium, on which the separation of the biological sample is performed through the first electrophoresis step, to a second electrophoresis chamber; and a second electrophoresis step of applying a voltage to the sample separation medium, which is conveyed to the second electrophoresis chamber, and separating the biological sample through SDS-polyacrylamide gel electrophoresis.

A separation method according to an aspect of the present invention includes a sample introducing step of introducing the biological sample to the sample separation medium using the sample introduction method of the present invention; and a first electrophoresis step of installing the sample separation medium in a third electrophoresis chamber that includes a flat installation surface, on which the sample separation medium is installed, and a first electrode and a second electrode which are connected to both the ends of the sample separation medium, applying the voltage between the first electrode and the second electrode of the third electrophoresis chamber in a state in which the sample separation medium adheres to the installation surface of the third electrophoresis chamber, and separating the biological sample through the isoelectric focusing.

In addition, the sample separation method according to the aspect of the present invention may further include a conveyance step of conveying the sample separation medium, in which the biological sample is separated through the first electrophoresis step, to a second electrophoresis chamber; and a second electrophoresis step of applying a voltage to the sample separation medium which is conveyed to the second electrophoresis chamber, and separating the biological sample through SDS-polyacrylamide gel electrophoresis.

### Sixth Embodiment

FIG. 15 is a view illustrating the schematic configuration of an electrophoresis device 14 according to a sixth embodiment. FIG. 16 is a view illustrating a state in which an IsoElectric Focusing (IEF) chip 40 is installed in the electrophoresis device 14.

The electrophoresis device 14 includes an electrophoresis instrument 11, a cover 50, a power supply 22, a voltage measuring device 20, a current measuring device 21, a voltage controller 13, and a conveyance arm 45.

The electrophoresis instrument 11 includes an electrophoresis chamber 1 for installing the IEF chip 40. The electrophoresis chamber 1 is a rectangular-shaped groove which is formed on one surface of the electrophoresis instrument 11, and the bottom surface of the electrophoresis chamber 1 is an installation surface 1a on which the IEF chip 40 is installed. The top of the electrophoresis chamber 1 is covered by the cover 50.

In the electrophoresis chamber 1, a first electrode 30 which is connected to the acidic side end of the IEF chip 40, and a second electrode 31 which is connected to the basic side end of the IEF chip 40 are installed. A sample holding part 7 is provided on the installation surface 1a of the electrophoresis chamber 1 in order to inject a sample solution which includes a biological sample, such as proteins or nucleic acids. The sample holding part 3 is provided between the first electrode 30 and the second electrode 31.

The first electrode 30 and the second electrode 31 are connected to the power supply 22. The power supply 22 is controlled by the voltage controller 13. It is possible to use an ordinary personal computer as the voltage controller 13. The power supply 22 is controlled using a development environment such as Laboratory Virtual Instrumentation Engineering Workbench (Lab VIEW).

The voltage controller 13 sends a signal for applying a designated voltage to the power supply 22. A voltage and a current, which are supplied from the power supply 22 to the first electrode 30 and the second electrode 31, are monitored by the voltage measuring device 20 and the current measuring device 21. The voltage measuring device 21 and the current measuring device 20 detect the voltage and the current, for example, at a frequency of once every 0.1 seconds or higher.

The IEF chip 40 includes a one-dimensional electrophoresis sample separation medium 42, and a support medium 41 which supports the sample separation medium 42. The sample separation medium 42 is a medium which separates a biological sample using isoelectric focusing. It is possible to use a gel, which is usually used as a one-dimensional gel in two-dimensional electrophoresis, as the sample separation medium 42. For example, an immobilized pH gradient (IPG) gel or the like, which is gelled by a gelling agent selected from a group consisting of polyacrylamide, agarose, agar, and farina, is suitable. It is possible to use, for example, a plastic plate, a film, or the like as the support medium 41.

The sample separation medium 42 may include a buffer solution. The buffer solution is a solution (solution in which pH does not largely change even when a small amount of acid or base is added or concentration changes a little) having a buffer action for hydrogen ion concentration. A weak acid, a solution, which includes a salt thereof, and the like are representative buffer solutions. It is preferable to use a buffer solution, which does not include polar molecules, as the buffer solution. For example, a buffer solution consisting of 8 M Urea, 2 M Thiourea, 4% CHAPS(3-[(3-Cholamidopropyl)dimethylammonio]propanesulfonate), 20 mM dithiothreitol, and 0.5% Ampholyte is suitable.

The IEF chip 40 is installed in the electrophoresis chamber 1 using the conveyance arm 45, and the introduction of the biological sample and one-dimensional electrophoresis (isoelectric focusing) of two-dimensional electrophoresis are performed. In the embodiment, both the introduction of the biological sample and the isoelectric focusing are performed in the electrophoresis chamber 1. However, the introduction of the biological sample may be performed in the electrophoresis chamber 1, and the isoelectric focusing may be performed in another electrophoresis chamber (third electrophoresis chamber 81).

The electrophoresis device 14 is provided with a second electrophoresis chamber 80 for separating the biological sample through second-dimensional electrophoresis (SDS-polyacrylamide gel electrophoresis (SDS-PAGE)). The IEF chip 40 in which the one-dimensional electrophoresis is completed, is conveyed to the second electrophoresis chamber 80 by the conveyance arm 45.

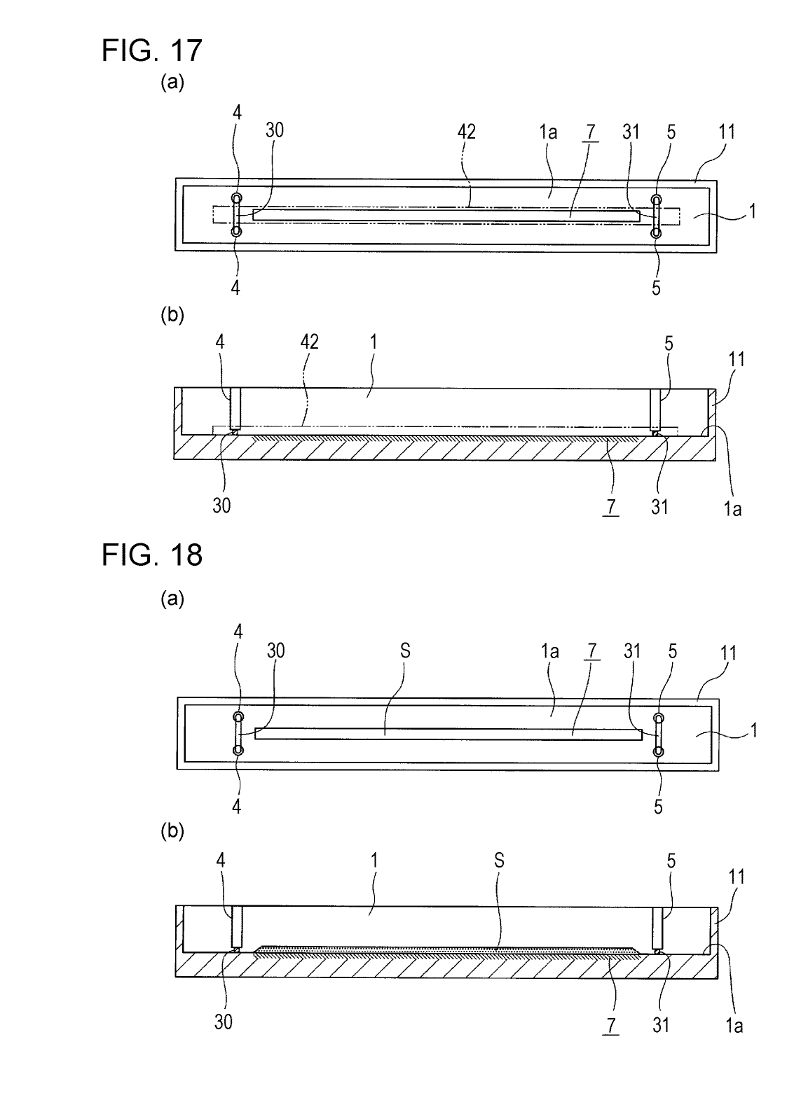

FIG. 17(a) is a plan view illustrating the electrophoresis instrument 10, and FIG. 17(b) is a cross-sectional view illustrating the electrophoresis instrument 10.

The electrophoresis instrument 11 has a cuboid shape, and the electrophoresis chamber 1, which has a long and narrow rectangular shape, is formed at the center of the electrophoresis instrument 11. One end side of the electrophoresis chamber 1 in the longitudinal direction has the first electrode 30 to which the acidic side end of the sample separation medium 42 is connected installed therein, and the other end side of the electrophoresis chamber 1 in the longitudinal direction has the second electrode 31 to which the basic side end of the sample separation medium 42 is connected installed therein.

On one end side and the other end side of the electrophoresis chamber 1 in the longitudinal direction, a first electrode holding part 4 and a second electrode holding part 5 for holding the first electrode 30 and the second electrode 31 are respectively provided. The first electrode holding part 4 and the second electrode holding part 5 are provided to be protruding from the installation surface 1a so as to interpose the acidic side end and the basic side end of the sample separation medium 42 therebetween, respectively.

The sample holding part 7 for holding the sample solution is formed on the bottom surface (the installation surface 1a on which the IEF chip is installed) of the electrophoresis chamber 1. The sample holding part 7 controls the wet spreading of the sample solution, and maintains the sample solution in a specific area of the installation surface 1a. The sample holding part 7 is formed as, for example, a hydrophilic part which has a stronger hydrophilic property than the installation surface 1a around the sample holding part 7. When the sample holding part 7 is formed as a hydrophilic part, the sample solution, which is supplied to the sample holding part 7, is not wet spread to the outside of the sample holding part 7. Therefore, the sample solution is stably maintained in the sample holding part 7.

It is possible to form the hydrophilic part using, for example, a method of performing a hydrophilic process, such as a UV process, on a part of the installation surface 1a, a method of forming a hydrophilic film, which has high wettability with regard to the sample solution, in a part of the installation surface 1a, a method of forming a part of the installation surface 1a using a material which has a strongly hydrophilic property, or the like. In addition, it is possible to form a water-resistant part on a part of the installation surface 1a using a method of forming a water-resistant film on a part of the installation surface 1a, a method of forming a part of the installation surface 1a using a highly water-resistant material, or the like, and it is possible to maintain the sample solution in a region interposed between the water-resistant parts.

In the embodiment, the sample holding part 7 is formed in an elongated shape from a side which is close to the first electrode 30 to a side which is close to the second electrode 31 while interposing the central part of the electrophoresis chamber 1. The length of the sample holding part 7 is slightly shorter than the distance between the first electrode 30 and the second electrode 31. The width of the sample holding part 7 is almost the same as the width of the sample separation medium 42, and the top of the sample holding part 7 is completely covered by the sample separation medium 42.

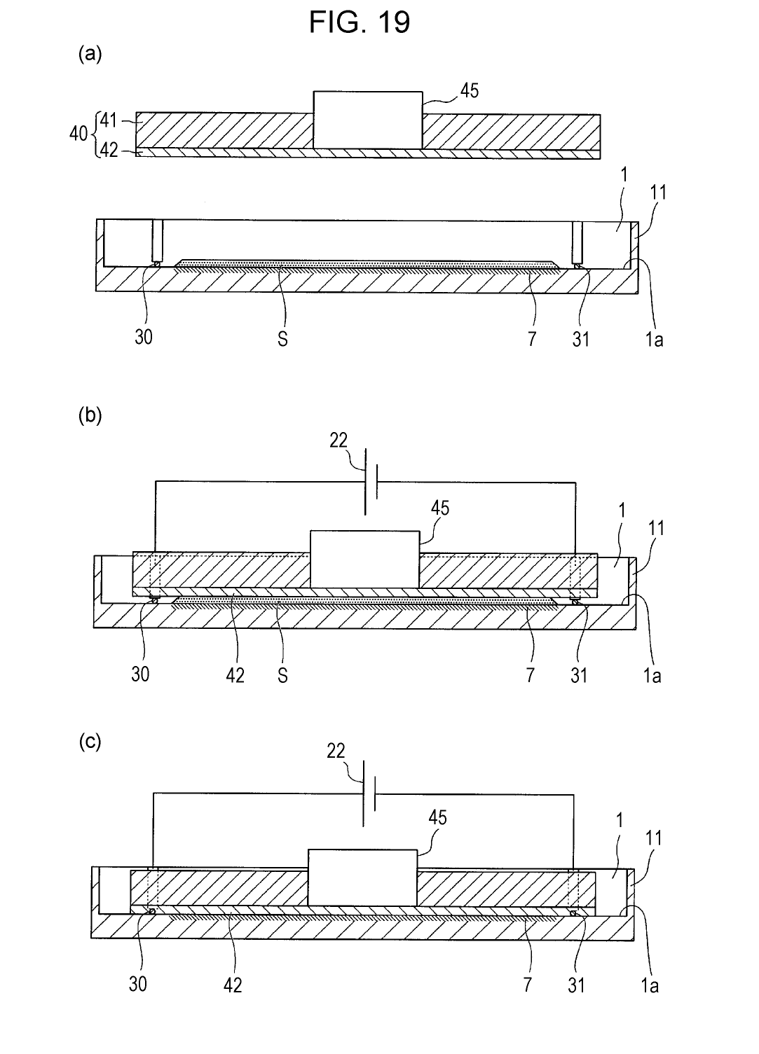

FIGS. 18 and 19 are explanatory views illustrating a sample introduction method of introducing the biological sample to the sample separation medium. FIG. 18(a) is a plan view illustrating the electrophoresis instrument, and FIGS. 18(b), 19(a), 19(b) and 19(c) are cross-sectional views illustrating the electrophoresis instrument.

The sample introduction method according to the embodiment is applied to the sample separation method of separating the biological sample through two-dimensional electrophoresis. The sample separation method according to the embodiment includes a sample introducing step of introducing the biological sample to the sample separation medium 42 using the sample introduction method according to the embodiment; a first electrophoresis step of applying a voltage between the first electrode 30 and the second electrode 32 and separating the biological sample through isoelectric focusing; a conveyance step of conveying the sample separation medium 42, in which the biological sample is separated by performing the first electrophoresis step, to the second electrophoresis chamber 80; and a second electrophoresis step of applying a voltage to the sample separation medium 42 which is conveyed to the second electrophoresis chamber 80, and separating the biological sample through SDS-polyacrylamide gel electrophoresis (SDS-PAGE).

The sample introduction method according to the embodiment includes a first step of supplying the sample solution S, which includes the biological sample, to the installation surface 1a on which the sample separation medium 42 is installed; and a second step of causing the sample separation medium 42 to come into contact with the sample solution S which is supplied to the installation surface 1a and introducing the biological sample to the sample separation medium 42.

More specifically, first, as shown in FIG. 18, the sample solution S which includes the biological sample, such as proteins or nucleic acids, is supplied to the sample holding part 7 which is provided on the installation surface 1a of the electrophoresis chamber 1. Since the sample holding part 7 has a higher affinity with regard to the sample solution S than the surrounding part thereof, the sample solution S does not wet spread to the outside of the sample holding part 7, and is reliably maintained in the sample holding part 7. Since the sample solution S rises from the installation surface 1a due to surface tension, the sample solution S reliably comes into contact with the sample separation medium.

Subsequently, as shown in FIG. 19(a), the IEF chip 40, in which the sample separation medium 42 is swollen using the buffer solution, is installed in the electrophoresis chamber 1 using the conveyance arm 45, and the sample separation medium 42 is caused to come into contact with the sample solution S which is maintained in the sample holding part 7. It is preferable that a non-saturated and non-swollen sample separation medium be used as the sample separation medium 42. Since the sample solution S rises from the installation surface 1a due to surface tension, the sample solution S reliably comes into contact with the sample separation medium 42. Further, as shown in FIG. 19(b), a voltage of approximately 200 V is applied between the first electrode 30 and the second electrode 31, and the biological sample having a charge is introduced to the sample separation medium 42. Thereafter, as shown in FIG. 19(c), isoelectric focusing is performed in such a way that the sample separation medium 42 is pushed into the sample holding part 3 (installation surface 1a) using the conveyance arm 45, and the voltage is caused to rise to 6000 V in a state in which the sample separation medium 42 adheres to the sample holding part 7.

After the isoelectric focusing is performed, the IEF chip 40 is extracted from the electrophoresis chamber 1 using the conveyance arm 45. Further, SDS equilibration is performed by immersing the sample separation medium 42 in a solution containing SDS, and the sample separation medium 42 is caused to be connected to a SDS-PAGE sample separation medium (polyacrylamide gel). Further, the IEF chip 40 is conveyed to the second electrophoresis chamber 80 (refer to FIG. 2) by the conveyance arm 45, and thus second-dimensional electrophoresis (SDS-PAGE) is performed.

As described above, in the electrophoresis device 14 according to the embodiment, the sample solution S is supplied to the electrophoresis chamber 1, and the biological sample is introduced to the sample separation medium 42 by causing the sample separation medium 42 to come into contact with the sample solution S. Further, a voltage is applied to the sample separation medium 42 in the electrophoresis chamber 1 without change, and isoelectric focusing is performed. Therefore, it is not necessary to use oil for preventing drying when the biological sample is introduced to the sample separation medium 42, filter paper for removing impurities, or the like. Accordingly, it is possible to acquire data having high reproducibility without a complicated operation.

In addition, in the electrophoresis device 14 according to the embodiment, the introduction of the biological sample is performed on the sample separation medium 42, and then the voltage is applied to the sample separation medium 42 in a state in which the sample separation medium 42 adheres to the sample holding part 7. Therefore, the voltage is uniformly applied to the sample separation medium 42, a sample introduction efficiency is high, and thus uniform focusing and high resolution separation are performed. Accordingly, it is possible to easily perform the separation of the biological sample using isoelectric focusing with excellent reproducibility.

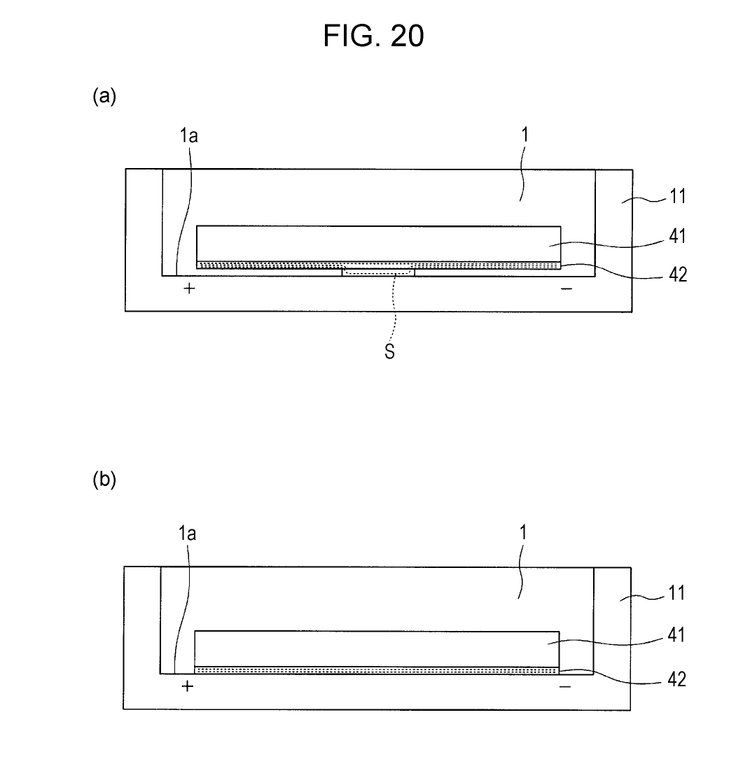

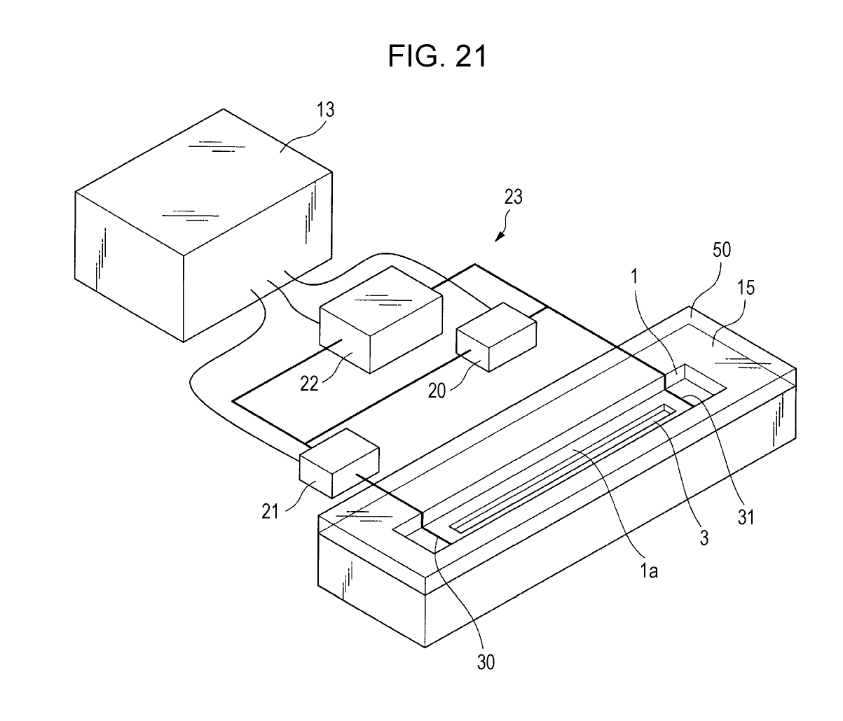

FIG. 20 is a view illustrating the change in the uniformity of a voltage which is applied to the sample separation medium 42 in a case in which the sample separation medium 42 adheres to the sample holding part and a case in which the sample separation medium 42 does not adhere to the sample holding part. FIG. 20(a) is a view illustrating the situation of the electric force lines of the inside of the sample separation medium 42 and the electric force lines of the surrounding part thereof when a voltage is applied to the sample separation medium 42 in a state in which the sample solution S remains between the sample holding part and the sample separation medium 42 without the sample separation medium 42 adhering to the sample holding part. FIG. 20(b) is a view illustrating the situation of the electric force lines of the inside of the sample separation medium 42 and the electric force lines of the surrounding part thereof when the voltage is applied to the sample separation medium 42 in a state in which the sample separation medium 42 adheres to the sample holding part and the sample solution S is not interposed between the sample holding part and the sample separation medium 42.

Meanwhile, when the electric force lines are simulated, the permittivity of the sample separation medium 42 and the sample solution S is the same as the permittivity of water.

As shown in FIG. 20(a), when the voltage is applied to the sample separation medium 42 in a state in which the sample solution S remains between the sample separation medium 42 and the sample holding part, the electric force lines of the inside of the sample separation medium 42 significantly curve toward the sample solution S at a part which comes into contact with the sample solution S. Therefore, even when the biological sample is introduced to the sample separation medium 42, the biological sample leaks to the outside of the sample separation medium 42 from the part which comes into contact with the sample solution S.

As shown in FIG. 20(b), if the voltage is applied to the sample separation medium 42 in a state in which the sample separation medium 42 adheres to the sample holding part, the electric force lines inside of the sample separation medium 42 are uniform, and thus a uniform voltage is applied to the entire sample separation medium 42. Accordingly, it is possible to perform uniform focusing and high resolution separation.

As above, the suitable forms of electrophoresis device and the electrophoresis chamber are described. However, the configurations of the electrophoresis device and the electrophoresis chamber are not limited thereto.

For example, in the embodiment, the sample holding part 7 is formed in an elongated shape from the side which is close to the first electrode 30 to the side which is close to the second electrode 31. However, a position in which the sample holding part 7 is formed is not particularly limited. For example, the sample holding part 3 may be formed at the central part of the electrophoresis chamber 1, and the sample holding part 7 may be formed in a position biased to the acidic side or the basic side rather than the central part of the electrophoresis chamber 1. When the sample holding part 7 is formed in a shape elongated in the longitudinal direction of the sample separation medium 42, it is easy for the biological sample to be uniformly introduced to the entire sample separation medium 42. If the sample holding part 7 is arranged by being biased to the acidic side or the basic side rather than being in the central part of the electrophoresis chamber 1, the migration length of the biological sample becomes longer when the biological sample is separated through isoelectric focusing, and thus resolution is improved.

In addition, in the embodiment, the width of the sample holding part 7 is approximately the same as the width of the sample separation medium 42. However, the width of the sample holding part 7 is not limited thereto. For example, the width of the sample holding part 7 may be wider than the width of the sample separation medium 42 and may be narrower than the width of the sample separation medium 42. When the partial or entire width of the sample holding part 7 is wider than the width of the sample separation medium 42, the top of the sample holding part 7 is not completely covered by the sample separation medium 42, and thus it is easy to discharge bubbles, which are generated when the sample separation medium 42 comes into contact with the sample solution, to the outside of the sample solution.

When the partial or entire width of the sample holding part 7 is wider than the width of the sample separation medium 42, it is preferable that the top of the electrophoresis chamber 1 be covered by the cover 50 in order to prevent drying of the sample solution. When the width of the entire sample holding part 7 is equal to or narrower than the width of the sample separation medium 42, it is not necessary to cover the top of the electrophoresis chamber 1 by the cover 50.

In addition, in the embodiment, the sample separation medium 42 adheres to the sample holding part 7 using the conveyance arm 45. However, a method of causing the sample separation medium 42 to adhere to the sample holding part 7 is not limited thereto. For example, the sample separation medium 42 may adhere to the sample holding part 7 due to swelling of the sample separation medium 42 when the sample solution S is absorbed into the sample separation medium 42.

### Seventh Embodiment

FIG. 21 is a view illustrating the schematic configuration of an electrophoresis device 23 according to a seventh embodiment.

The embodiment is different from the sixth embodiment in that the sample holding part 2 is formed as a depression into which the sample solution is injected.

In the embodiment, the sample holding part 2 is formed in an elongated shape from a side which is close to the first electrode 30 to a side which is close to the second electrode 31 while interposing the central part of the electrophoresis chamber 1. The length of the sample holding part 3 is slightly less than the distance between the first electrode 30 and the second electrode 31. The width of the sample holding part 3 is almost the same as the width of the sample separation medium 42, and the top of the sample holding part 3 is completely covered by the sample separation medium 42. The capacity of the sample holding part 3 is slightly less than the volume of the sample solution which is injected into the sample holding part 3. The depth of the sample holding part 3 is shallower than the thickness of the sample separation medium, and the sample separation medium 42 adheres to the bottom surface and the inner wall surfaces of the sample holding part 3 when the sample separation medium is pushed into the sample holding part 3.

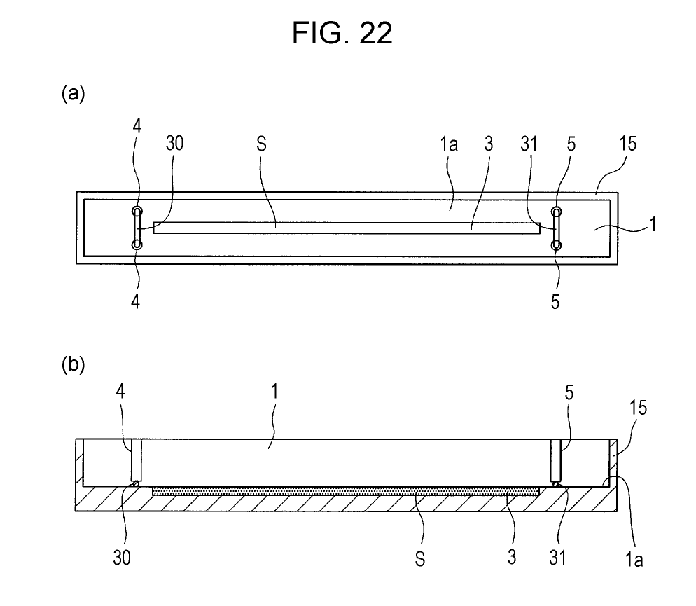

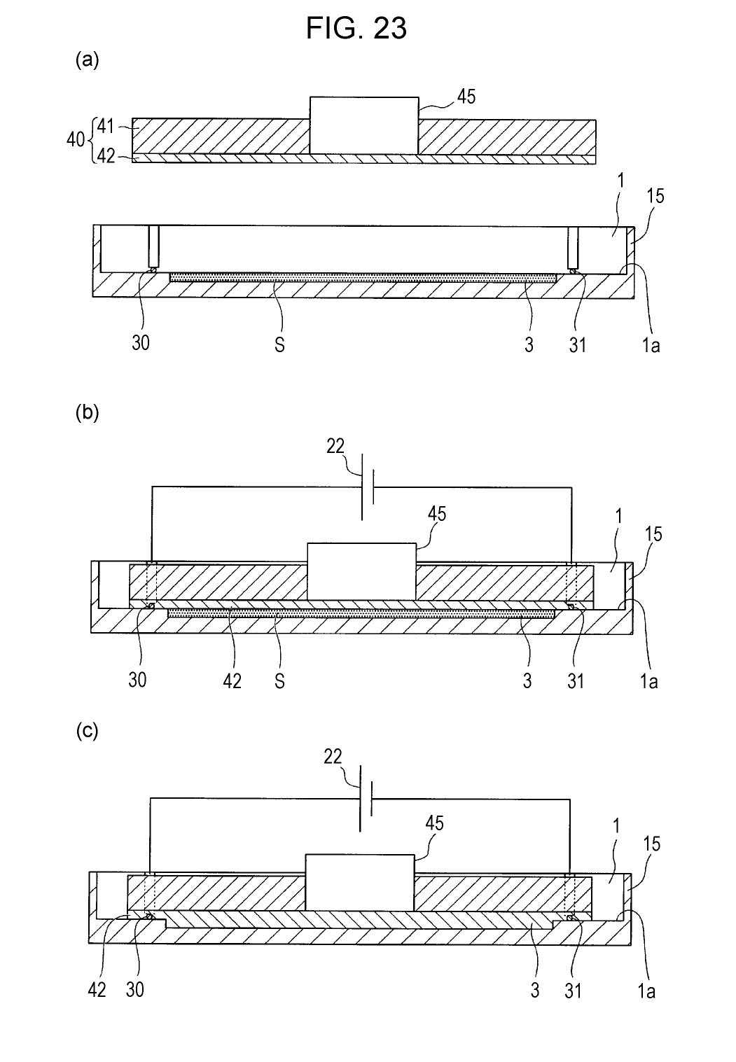

FIGS. 22 and 23 are explanatory views illustrating a sample introduction method of introducing the biological sample to the sample separation medium. FIG. 22(a) is a plan view illustrating an electrophoresis instrument 15, and FIGS. 22(b), 23(a), 23(b) and 23(c) are cross-sectional views illustrating the electrophoresis instrument 15.

In the embodiment, first, as shown in FIG. 22, the sample solution S, which includes the biological sample, such as proteins or nucleic acids, is injected into the sample holding part 3 which is provided on the installation surface 1a of the electrophoresis chamber 1 and has a depth of approximately 0.5 mm to 1 mm. It is possible to acquire optimum experimental results if the depth of the sample holding part 3 is in a range which is greater than 0 mm and less than 15 mm, and further preferable experimental results can be acquired in a range which is equal to or greater than 0.5 mm and equal to or less than 1 mm. The sample solution S is caused to slightly rise from the installation surface 1a such that the sample solution S reliably comes into contact with the sample separation medium. When the amount of sample solution S is not sufficient, the amount of sample solution S is adjusted by adding buffer solution such that the sample holding part 3 is filled with the sample solution S.

Subsequently, as shown in FIG. 23(a), the IEF chip 40, in which the sample separation medium 42 has become saturated and swollen using the buffer solution, is installed in the electrophoresis chamber 1 using the conveyance arm 45, the sample holding part 2, into which the sample solution S is injected, is covered by the sample separation medium 42, and the sample separation medium 42 adheres to the sample holding part 3. Further, as shown in FIG. 23(b), a voltage of approximately 200 V is applied between the first electrode 30 and the second electrode 31, and thus the biological sample having a charge is introduced to the sample separation medium 42. When the voltage is applied in a state in which the sample separation medium 42 is spread to the bottom of the sample holding part 2, the voltage is uniformly applied to the sample separation medium 42, and the biological sample is efficiently introduced to the sample separation medium 42. Thereafter, as shown in FIG. 23(c), the voltage rises to 6000 V by pushing the sample separation medium 42 into the sample holding part 3 using the conveyance arm 45, and thus isoelectric focusing is performed.

After the isoelectric focusing is performed, the IEF chip 40 is extracted from the electrophoresis chamber 1 using the conveyance arm 45. Further, SDS equilibration is performed by immersing the sample separation medium 42 in a solution containing SDS, and the sample separation medium 42 is caused to be connected to a SDS-PAGE sample separation medium (polyacrylamide gel). Further, the IEF chip 40 is conveyed to the second electrophoresis chamber 80 (refer to FIG. 2) by the conveyance arm 45, and thus second-dimensional electrophoresis (SDS-PAGE) is performed.

As described above, in the electrophoresis device 23 according to the embodiment, the sample solution S is supplied to the electrophoresis chamber 1, the sample separation medium 42 is put on the sample solution S, and the introduction of the biological sample is performed. Further, a voltage is applied to the sample separation medium 42 in the electrophoresis chamber 1 without change, and isoelectric focusing is performed. Since oil for preventing drying, filter paper for removing impurities, or the like is not used when the introduction of the biological sample is performed on the sample separation medium 42, complicated operations are not performed, and thus it is possible to acquire data having high reproducibility.

In addition, in the electrophoresis device 23 according to the embodiment, the introduction of the biological sample to the sample separation medium 42 is performed, and then the voltage is applied to the sample separation medium 42 in a state in which the sample separation medium 42 adheres to the sample holding part 3. Therefore, the voltage is uniformly applied to the sample separation medium 42, a sample introduction efficiency is high, and thus uniform focusing and high resolution separation are performed. Accordingly, it is possible to easily perform the separation of the biological sample using isoelectric focusing with excellent reproducibility.

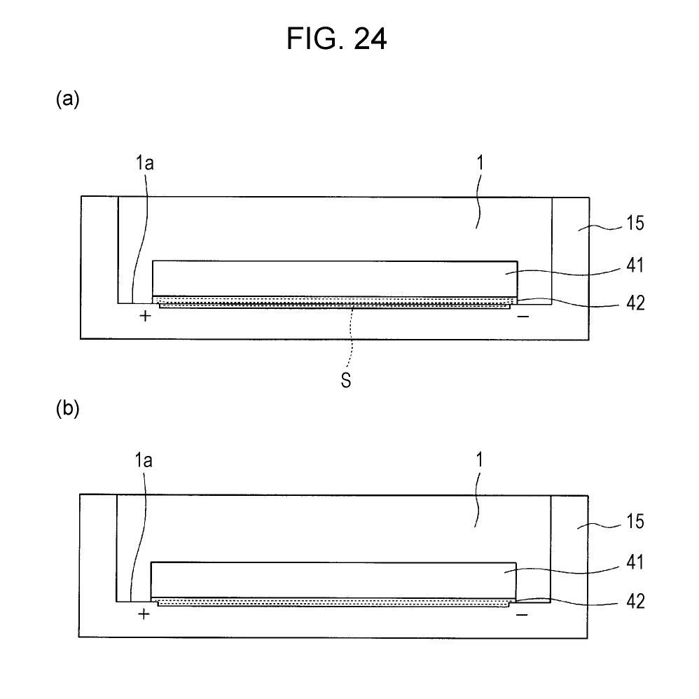

FIG. 24 is a view illustrating the change in uniformity of a voltage which is applied to the sample separation medium 42 in a case in which a sample separation medium 42 adheres to a sample holding part and a case in which the sample separation medium 42 does not adhere to the sample holding part. FIG. 24(a) is a view illustrating the situation of the electric force lines of the inside of the sample separation medium 42 and the electric force lines of the surrounding part thereof when the voltage is applied to the sample separation medium 42 in a state in which the sample solution S remains between the bottom surface and the inner wall surfaces of the sample holding part and the sample separation medium 42 without the sample separation medium 42 adhering to the sample holding part. FIG. 24(b) is a view illustrating the situation of the electric force lines of the inside of the sample separation medium 42 and the electric force lines of the surrounding part thereof when the voltage is applied to the sample separation medium 42 in a state in which the sample separation medium 42 adheres to the bottom surface and the inner wall surfaces of the sample holding part and the sample solution S is not interposed between the bottom surface and the inner wall surfaces of the sample holding part and the sample separation medium 42.

Meanwhile, when the electric force lines are simulated, the permittivity of the sample separation medium 42 and the sample solution S is the same as the permittivity of water.

As shown in FIG. 24(a), when the voltage is applied to the sample separation medium 42 in a state in which the sample solution S remains between the sample separation medium 42 and the bottom surface and the inner wall surfaces of the sample holding part, the electric force lines of the inside of the sample separation medium 42 significantly curve toward the sample solution S at a part which comes into contact with the sample solution S. Therefore, even when the biological sample is introduced to the sample separation medium 42, the biological sample leaks to the outside of the sample separation medium 42 from the part which comes into contact with the sample solution S.

As shown in FIG. 24(b), if the voltage is applied to the sample separation medium 42 in a state in which the sample separation medium 42 adheres to the bottom surface and the inner wall surfaces of the sample holding part, the electric force lines inside of the sample separation medium 42 are uniform, and thus a uniform voltage is applied to the entire sample separation medium 42. Accordingly, it is possible to perform uniform focusing and high resolution separation.

As above, the suitable forms of electrophoresis device and the electrophoresis chamber are described. However, the configurations of the electrophoresis device and the electrophoresis chamber are not limited thereto.

For example, in the embodiment, the sample holding part 3 is formed in an elongated shape from the vicinity of the first electrode 30 to the vicinity of the second electrode 31. However, a position in which the sample holding part 3 is formed is not particularly limited. For example, the sample holding part 3 may be formed at the central part of the electrophoresis chamber 1 or the sample holding part 3 may be formed at a position biased to an acidic side or a basic side rather than the central part of the electrophoresis chamber 1. When the sample holding part 2 is formed in a shape elongated in the longitudinal direction of the sample separation medium 42, it is easy for the biological sample to be uniformly introduced to the entire sample separation medium 42. When the sample holding part 3 is arranged to be biased to the acidic side or the basic side rather than the central part of the electrophoresis chamber 1, the migration length of the biological sample becomes longer when the biological sample is separated through isoelectric focusing, and thus resolution is improved.

In addition, in the embodiment, the width of the sample holding part 3 is approximately the same as the width of the sample separation medium 42. However, the width of the sample holding part 3 is not limited thereto. For example, the width of the sample holding part 3 may be wider than the width of the sample separation medium 42 or may be narrower than the width of the sample separation medium 42. When the partial or entire width of the sample holding part 3 is wider than the width of the sample separation medium 42, the top of the sample holding part 3 is not completely covered by the sample separation medium 42, and thus it is easy to discharge bubbles, which are generated when the sample separation medium 42 comes into contact with the sample solution, to the outside of the sample solution.

When the partial or entire width of the sample holding part 3 is wider than the width of the sample separation medium 42, it is preferable that the top of the electrophoresis chamber 1 be covered by a cover 50 in order to prevent drying of the sample solution. When the width of the entire sample holding part 3 is equal to or narrower than the width of the sample separation medium 42, it is not necessary to cover the top of the electrophoresis chamber 1 by the cover 50.

In addition, in the embodiment, the sample separation medium 42 is caused to adhere to the bottom surface and the inner wall surfaces of the sample holding part 3 using the conveyance arm 45. However, a method of causing the sample separation medium 42 to adhere to the bottom surface and the inner wall surfaces of the sample holding part 3 is not limited thereto. For example, the sample separation medium 42 may adhere to the bottom surface and inner wall surfaces of the sample holding part 3 due to swelling of the sample separation medium 42 when the sample solution S is absorbed into the sample separation medium 42.

In addition, in the embodiment, both the introduction of the biological sample and isoelectric focusing are performed in the electrophoresis chamber 1. However, the introduction of the biological sample may be performed in the electrophoresis chamber 1 and the isoelectric focusing may be performed in another electrophoresis chamber (third electrophoresis chamber 81).

The third electrophoresis chamber 81 is an electrophoresis chamber having a flat installation surface on which the sample separation medium 42 is installed. Although the third electrophoresis chamber 81 is different from the electrophoresis chamber 1 in that a depression is not formed on the installation surface, the other configurations are the same as those of the electrophoresis chamber 1. Accordingly, the detailed configuration of the third electrophoresis chamber 81 is not shown in the drawing.

The sample separation medium 42, in which the introduction of the biological sample is performed in the electrophoresis chamber 1, is installed in the third electrophoresis chamber 81 (refer to FIG. 16) using the conveyance arm 45 (refer to FIG. 16). Further, a voltage of 6000 V is applied to the sample separation medium 42 using the first electrode and the second electrode which are provided in the third electrophoresis chamber 81, and thus the separation of the biological sample is performed through isoelectric focusing. In this case, since the isoelectric focusing is performed using the third electrophoresis chamber 81 which has a flat installation surface, a uniform voltage is applied to the entire sample separation medium 42, and thus it is possible to realize uniform focusing and high resolution separation.

### Eighth Embodiment

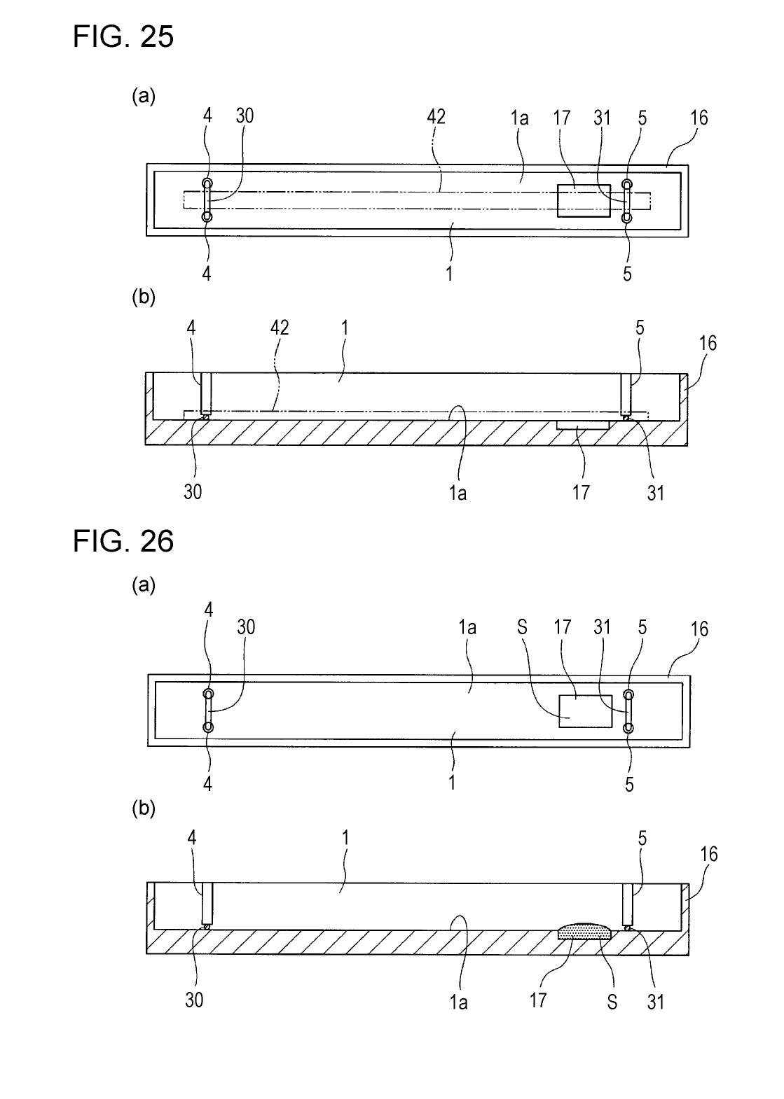

FIG. 25(a) is a plan view illustrating an electrophoresis instrument 16 according to a third embodiment, and FIG. 25(b) is a cross-sectional view illustrating the electrophoresis instrument 16.

The embodiment is different from the seventh embodiment in that a sample holding part 17 is arranged to be biased to the acidic side or the basic side rather than being in the center of the electrophoresis chamber 1. In a case of the embodiment, the sample holding part 17 is provided on a side which is closer to the second electrode 31 than the first electrode 30. However, the sample holding part 17 may be provided on a side which is closer to the first electrode 30 than the second electrode 31.

It is preferable that the capacity of the sample holding part 17 be slightly smaller than the volume of the sample solution which is injected into the sample holding part 17. According to the configuration, when the sample solution is injected into the sample holding part 17, the sample solution rises from the installation surface 1a, and thus the sample solution reliably comes into contact with the sample separation medium 42.

The area of the sample holding part 17 may be an area in which it is possible to acquire a sufficient contact area between the sample solution and the sample separation medium 42, and is not particularly limited. In FIG. 25, the width of the sample holding part 17 is greater than the width of the sample separation medium 42. However, the width of the sample holding part 17 may be smaller than the width of the sample separation medium 42. When the partial or entire width of the holding part 17 is wider than the width of the sample separation medium 42, the top of the sample holding part 17 is not completely covered by the sample separation medium 42, and thus it is easy to discharge bubbles, which are generated when the sample separation medium 42 comes into contact with the sample solution, to the outside of the sample solution.

When the partial or entire width of the sample holding part 17 is wider than the width of the sample separation medium 42, it is preferable that the top of the electrophoresis chamber 1 be covered by the cover 50 (refer to FIG. 15) in order to prevent drying of the sample solution. When the width of the whole sample holding part 17 is equal to or narrower than the width of the sample separation medium 42, it is not necessary to cover the top of the electrophoresis chamber 1 by the cover 50 (refer to FIG. 15).

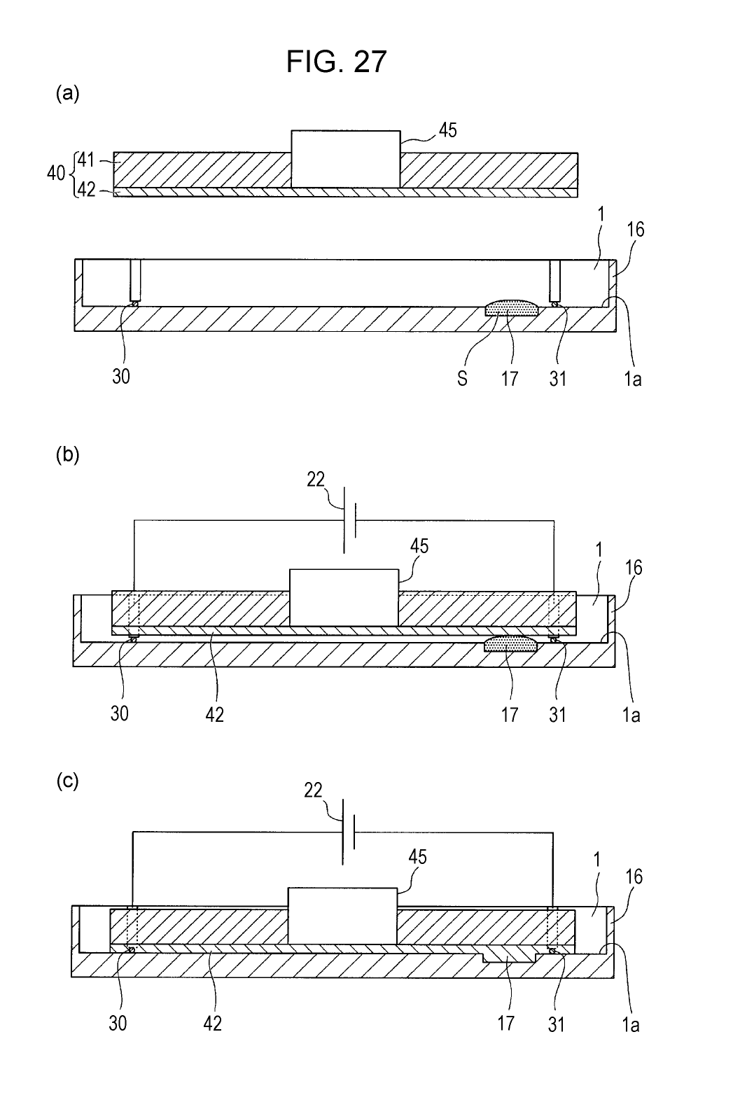

FIGS. 26 and 27 are explanatory views illustrating a sample introduction method of introducing the biological sample to the sample separation medium. FIG. 26(a) is a plan view illustrating the electrophoresis instrument 16, and FIGS. 26(b), 27(a), 27(b), and 27(c) are cross-sectional views illustrating the electrophoresis instrument 16.

In the embodiment, first, as shown in FIG. 26, the sample solution S, which includes the biological sample, such as proteins or nucleic acids, is injected into the sample holding part 17 which is provided on the installation surface 1a of the electrophoresis chamber 1 and has a depth of approximately 0.5 mm to 1 mm. It is possible to acquire optimum experimental results if the depth of the sample holding part 17 is in a range which is greater than 0 mm and less than 15 mm, and further preferable experimental results can be acquired in a range which is equal to or greater than 0.5 mm and equal to or less than 1 mm. The sample solution S is caused to slightly rise from the installation surface 1a such that the sample solution S reliably comes into contact with the sample separation medium. When the amount of sample solution S is not sufficient, the amount of sample solution S is adjusted by adding the buffer solution such that the sample holding part 17 is filled with the sample solution S.

Subsequently, as shown in FIG. 27(a), the IEF chip 40, in which the sample separation medium 42 has become saturated and swollen using the buffer solution, is installed in the electrophoresis chamber 1 using the conveyance arm 45, the sample holding part 17, into which the sample solution S is injected, is covered by the sample separation medium 42, and the sample separation medium 42 adheres to the sample holding part 17. Further, as shown in FIG. 27(b), a voltage of approximately 200 V is applied between the first electrode 30 and the second electrode 31, and thus the biological sample having a charge is introduced to the sample separation medium 42. Thereafter, as shown in FIG. 27(c), the voltage rises to 6000 V by pushing the sample separation medium 42 into the sample holding part 17 using the conveyance arm 45, and thus isoelectric focusing is performed.

After the isoelectric focusing is performed, the IEF chip 40 is extracted from the electrophoresis chamber 1 using the conveyance arm 45. Further, SDS equilibration is performed by immersing the sample separation medium 42 in a solution containing SDS, and the sample separation medium 42 is caused to be connected to a SDS-PAGE sample separation medium (polyacrylamide gel). Further, the IEF chip 40 is conveyed to the second electrophoresis chamber 80 (refer to FIG. 2) by the conveyance arm 45, and thus second-dimensional electrophoresis (SDS-PAGE) is performed.

As above, in the electrophoresis instrument 16 according to the embodiment, the sample holding part 17 is arranged to be biased to an acidic side or a basic side rather than being in the central part of the electrophoresis chamber 1. Therefore, when the biological sample is separated through isoelectric focusing, the migration length of the biological sample is longer, and thus resolution is improved.

### [Second Modification]

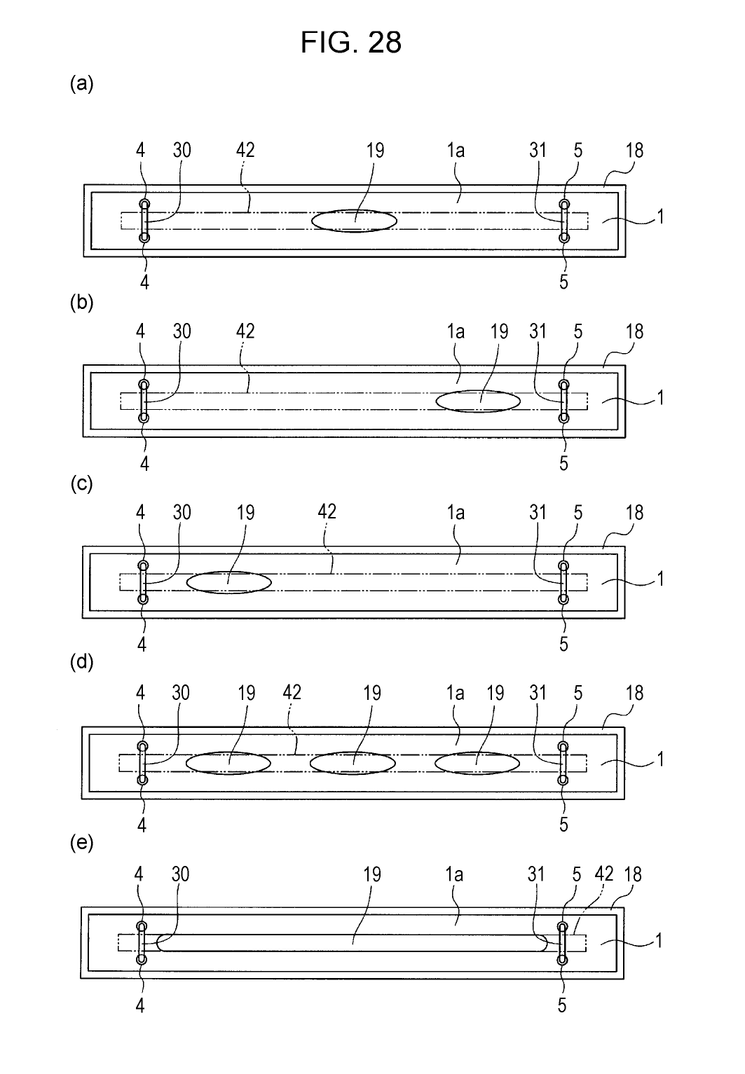

FIGS. 28(a) to 28(e) are plan views illustrating examples of other variations of a sample holding part 19 which is provided in an electrophoresis instrument 18.

FIG. 28(a) shows an example in which an elliptical sample holding part 19 is provided at the central part of the electrophoresis chamber 1. FIG. 28(b) shows an example in which the elliptical sample holding part 19 is provided to be biased to the side of the second electrode 31 rather than being in the central part of the electrophoresis chamber 1. FIG. 28(c) shows an example in which the elliptical sample holding part 19 is provided to be biased to the side of the first electrode 30 rather than being in the central part of the electrophoresis chamber 1. FIG. 28(d) shows an example in which three elliptical sample holding parts 19 are arranged to be separated from each other along the longitudinal direction of the electrophoresis chamber 1. FIG. 28(a) shows an example in which an approximately rectangular-shaped sample holding part 19, in which the side of the first electrode 30 and the side of the second electrode 31 are curved into arc shapes, is formed in an elongated shape from a side which is close to the first electrode 30 to a side which is close to the second electrode 31 while interposing the central part of the electrophoresis chamber 1.

The shape, arrangement, and number of the sample holding parts 19 shown in FIG. 28 are examples, and it is possible to form the sample holding part 19, which has various shapes, arrangements, and numbers other than those examples, in the electrophoresis chamber 1. The sample holding part 19 may be formed as a hydrophilic part which has an affinity with regard to the sample solution, and may be formed as a depression into which the sample solution is injected.

### [Third Modification]

In the embodiments and the first modification, the sample holding part 3, 7, 17, or 19 for holding the sample solution S is provided on the installation surface 1a of the electrophoresis chamber 1. Although the sample holding part 3, 7, 17, or 19 suppresses the wet spreading of the sample solution S, the sample holding part 3, 7, 17, or 19 may not be provided on the installation surface 1a of the electrophoresis chamber 1 if significant problems do not occur when the biological sample is introduced even if the sample solution S wet spreads a little.

For example, when the width of the electrophoresis chamber 1 is approximately the same as the width of the sample separation medium 42, there is no problem of the wet spreading of the sample solution S. Accordingly, it is possible to introduce the biological sample to the sample separation medium 42 by simply supplying the sample solution S to the installation surface 1a and putting the sample separation medium 42 thereon without providing the sample holding part. After the biological sample is introduced to the sample separation medium 42, the sample separation medium 42 adheres to the installation surface 1a of the electrophoresis chamber 1, and the voltage is applied between the first electrode 30 and the second electrode 31, and thus uniform focusing and high-resolution separation are performed.

### [Summary of Sixth to Eight Embodiments]

A sample introduction method according to an aspect of the present invention is a sample introduction method of introducing a biological sample to a sample separation medium for separating the biological sample through electrophoresis, and the method includes: a first step of supplying a sample solution to a sample holding part of an electrophoresis chamber that includes an installation surface on which the sample separation medium is installed, and a first electrode and a second electrode which are connected to both ends of the sample separation medium, and that is provided with the sample holding part which maintains the sample solution while suppressing wet spreading of the sample solution, which includes the biological sample, on the installation surface; and a second step of causing the sample separation medium to come into contact with the sample solution, which is supplied to the sample holding part, and introducing the biological sample to the sample separation medium.

In addition, in the sample introduction method according to the aspect of the present invention, the second step may include causing the sample solution to come into contact with the sample separation medium while applying a voltage between the first electrode and the second electrode.

In addition, in the sample introduction method according to the aspect of the present invention, the sample holding part may be a hydrophilic part which has a stronger hydrophilic property than the installation surface around the sample holding part.

In addition, in the sample introduction method according to the aspect of the present invention, the sample holding part may be a depression which is provided on the installation surface.

In addition, in the sample introduction method according to the aspect of the present invention, a depth of the depression may be less than a thickness of the sample separation medium.

In addition, in the sample introduction method according to the aspect of the present invention, the sample holding part may be provided on a side, which is closer to the first electrode than the second electrode, or a side which is closer to the second electrode than the first electrode.

In addition, in the sample introduction method according to the aspect of the present invention, the sample separation medium may be a swollen gel. In this case, a gel, which is not completely swollen, is preferable because it is possible to absorb the sample solution.

A sample separation method according to an aspect of the present invention includes: a sample introducing step of introducing the biological sample to the sample separation medium using the sample introduction method according to the present invention; and a first electrophoresis step of applying a voltage between the first electrode and the second electrode, and separating the biological sample through isoelectric focusing.

In addition, in the sample separation method according to the aspect of the present invention, the first electrophoresis step may include applying a voltage between the first electrode and the second electrode in a state in which the sample separation medium adheres to the installation surface.

In addition, a method of adhering the sample separation medium to the installation surface of the electrophoresis chamber in the sample separation method according to the aspect of the present invention includes the following methods. A first method is a method of adhering the sample separation medium to the installation surface of the electrophoresis chamber in such a way that a non-saturated and swollen gel, which is the sample separation medium, absorbs the sample solution and swells. A second method is a method of pushing the sample separation medium into the installation surface of the electrophoresis chamber using a conveyance arm. That is, the sample introducing step may include adhering the sample separation medium to the installation surface in such a way that the sample separation medium absorbs the sample solution and swells. In addition, the first electrophoresis step may include adhering the sample separation medium to the installation surface by pushing the sample separation medium into the installation surface using the conveyance arm.

In addition, the sample separation method according to the aspect of the invention may further include a conveyance step of conveying the sample separation medium, in which the biological sample is separated using the first electrophoresis step, to a second electrophoresis chamber; and a second electrophoresis step of applying a voltage to the sample separation medium, which is conveyed to the second electrophoresis chamber, and separating the biological sample through SDS-polyacrylamide gel electrophoresis.

A sample separation method according to an aspect of the present invention includes: a sample introducing step of introducing the biological sample to the sample separation medium using the sample introduction method according to the present invention; and a first electrophoresis step of installing the sample separation medium in a third electrophoresis chamber that includes a flat installation surface on which the sample separation medium is installed, and a first electrode and a second electrode which are connected to both ends of the sample separation medium, applying a voltage between the first electrode and the second electrode of the third electrophoresis chamber in a state in which the sample separation medium adheres to the installation surface of the third electrophoresis chamber, and separating the biological sample through isoelectric focusing.

In addition, the sample separation method according to the aspect of the present invention may further include a conveyance step of conveying the sample separation medium, in which the biological sample is separated using the first electrophoresis step, to a second electrophoresis chamber; and a second electrophoresis step of applying a voltage to the sample separation medium, which is conveyed to the second electrophoresis chamber, and separating the biological sample through SDS-polyacrylamide gel electrophoresis.

An electrophoresis instrument according to an aspect of the present invention includes an electrophoresis chamber that includes an installation surface on which a sample separation medium for separating a biological sample through electrophoresis is installed, and a first electrode and a second electrode that are connected to both ends of the sample separation medium, and a sample holding part, which maintains a sample solution while suppressing wet spreading of the sample solution, which includes the biological sample, is provided on the installation surface of the electrophoresis chamber.

### INDUSTRIAL APPLICABILITY

It is possible to suitably use the present invention for means that separates a biological sample, such as proteins or nucleic acids, through electrophoresis, extracts a sample separation medium including the separated biological sample and identifies the sample separation medium using a mass spectrometry apparatus, or transfers the separated biological sample to a film from the sample separation medium and detects the biological sample using an immune reaction or the like.

### REFERENCE SIGNS LIST

1, 70 electrophoresis chamber
1a, 71a installation surface
2, 61, 63, 65, 69 depression
3, 7, 17, 19 sample holding part
10, 11, 15, 16, 18, 60, 62, 64, 66 electrophoresis instrument
12, 14, 23 electrophoresis device
30 first electrode
31 second electrode
42 sample separation medium
45 conveyance arm
80 second electrophoresis chamber
81 third electrophoresis chamber
S sample solution

1-31. (canceled)

32. An electrophoresis instrument comprising:
an electrophoresis chamber that includes an installation surface on which a sample separation medium for separating a biological sample through electrophoresis is installed, and a first electrode and a second electrode that are connected to both ends of the sample separation medium,
wherein a depression for injecting a sample solution that includes the biological sample is formed on the installation surface of the electrophoresis chamber, and
wherein the sample separation medium is a swollen gel.

33. The electrophoresis instrument according to claim 32,
wherein the depression is provided on a side which is closer to the first electrode than the second electrode or a side which is closer to the second electrode than the first electrode.

34. The electrophoresis instrument according to claim 32,
wherein the depression is formed from a side which is close to the first electrode to a side which is close to the second electrode while interposing a central part of the electrophoresis chamber therebetween.

35. The electrophoresis instrument according to claim 32,
wherein a capacity of the depression is smaller than a volume of the sample solution which is injected into the depression.

36. The electrophoresis instrument according to claim 32,
wherein at least a part of the depression is formed to have a wider width than the sample separation medium.

37. An electrophoresis device comprising:
the electrophoresis instrument according to claim 32;
a conveyance arm that installs the sample separation medium in the electrophoresis chamber; and
a second electrophoresis chamber in which the sample separation medium is installed,
wherein the conveyance arm conveys the sample separation medium between the electrophoresis chamber and the second electrophoresis chamber.

38. The electrophoresis device according to claim 37, further comprising:
a third electrophoresis chamber that includes a flat installation surface on which the sample separation medium is installed, and a first electrode and a second electrode that are connected to both ends of the sample separation medium,
wherein the conveyance arm conveys the sample separation medium between the third electrophoresis chamber and the second electrophoresis chamber.

39. A sample introduction method of introducing a biological sample to a sample separation medium for separating the biological sample through electrophoresis, the method comprising:
a first step of injecting a sample solution, which includes the biological sample, into a depression on an installation surface of an electrophoresis chamber that includes the installation surface, on which the sample separation medium is installed, a first electrode and a second electrode which are connected to both ends of the sample separation medium, and the depression which is formed on the installation surface; and
a second step of causing the sample separation medium to come into contact with the sample solution injected into the depression, and introducing the biological sample to the sample separation medium.

40. The sample introduction method according to claim 39,
wherein, in the second step, the sample solution is caused to come into contact with the sample separation medium while a voltage is applied between the first electrode and the second electrode.

41. A sample separation method comprising:
a sample introducing step of introducing the biological sample to the sample separation medium using the sample introduction method according to claim 39; and
a first electrophoresis step of applying a voltage between the first electrode and the second electrode, and separating the biological sample through isoelectric focusing.

42. The sample separation method according to claim 41, further comprising:
a conveyance step of conveying the sample separation medium, in which the biological sample has been separated using the first electrophoresis step, to a second electrophoresis chamber; and
a second electrophoresis step of applying a voltage to the sample separation medium, which has been conveyed to the second electrophoresis chamber, and separating the biological sample through SDS-polyacrylamide gel electrophoresis.

43. A sample separation method comprising:
a sample introducing step of introducing the biological sample to the sample separation medium using the sample introduction method according to claim 39; and
a first electrophoresis step of installing the sample separation medium in a third electrophoresis chamber that includes a flat installation surface on which the sample separation medium is installed, and a first electrode and a second electrode which are connected to both ends of the sample separation medium, applying a voltage between the first electrode and the second electrode of the third electrophoresis chamber in a state in which the sample separation medium adheres to the installation surface of the third electrophoresis chamber, and separating the biological sample through isoelectric focusing.

44. The sample separation method according to claim 43, further comprising:
a conveyance step of conveying the sample separation medium, in which the biological sample has been separated using the first electrophoresis step, to a second electrophoresis chamber; and
a second electrophoresis step of applying a voltage to the sample separation medium, which has been conveyed to the second electrophoresis chamber, and separating the biological sample through SDS-polyacrylamide gel electrophoresis.

45. A sample introduction method of introducing a biological sample to a sample separation medium for separating the biological sample through electrophoresis, the method comprising:
a first step of supplying a sample solution to a sample holding part of an electrophoresis chamber that includes an installation surface on which the sample separation medium is installed, and a first electrode and a second electrode which are connected to both ends of the sample separation medium, and that is provided with the sample holding part which maintains the sample solution while suppressing wet spreading of the sample solution, which includes the biological sample, on the installation surface; and
a second step of causing the sample solution supplied to the sample holding part to come into contact with the sample separation medium while applying a voltage between the first electrode and the second electrode, and introducing the biological sample to the sample separation medium,
wherein the sample separation medium is a swollen gel.

46. The sample introduction method according to claim 45,
wherein the sample holding part is a hydrophilic part which has a stronger hydrophilic property than the installation surface around the sample holding part.

47. The sample introduction method according to claim 45,
wherein the sample holding part is a depression which is provided on the installation surface.

48. The sample introduction method according to claim 47,
wherein a depth of the depression is less than a thickness of the sample separation medium.

49. The sample introduction method according to claim 45,
wherein the sample holding part is provided on a side which is closer to the first electrode than the second electrode or a side which is closer to the second electrode than the first electrode.

50. A sample separation method comprising:
a sample introducing step of introducing the biological sample to the sample separation medium using the sample introduction method according to claim 45; and
a first electrophoresis step of applying a voltage between the first electrode and the second electrode, and separating the biological sample through isoelectric focusing.

51. The sample separation method according to claim 50,
wherein in the first electrophoresis step, the voltage is applied between the first electrode and the second electrode in a state in which the sample separation medium adheres to the installation surface.

52. The sample separation method according to claim 51,
wherein in the sample introducing step, the sample separation medium is adhered to the installation surface in such a way that the sample separation medium absorbs the sample solution and swells.

53. The sample separation method according to claim 51,
wherein in the first electrophoresis step, the sample separation medium is adhered to the installation surface by pushing the sample separation medium to the installation surface using a conveyance arm.

54. The sample separation method according to claim 50, further comprising:
a conveyance step of conveying the sample separation medium, in which the biological sample has been separated using the first electrophoresis step, to a second electrophoresis chamber; and
a second electrophoresis step of applying a voltage to the sample separation medium, which has been conveyed to the second electrophoresis chamber, and separating the biological sample through SDS-polyacrylamide gel electrophoresis.

55. A sample separation method comprising:
a sample introducing step of introducing the biological sample to the sample separation medium using the sample introduction method according to claim 45; and
a first electrophoresis step of installing the sample separation medium in a third electrophoresis chamber that includes a flat installation surface on which the sample separation medium is installed, and a first electrode and a second electrode which are connected to both ends of the sample separation medium, applying a voltage between the first electrode and the second electrode of the third electrophoresis chamber in a state in which the sample separation medium adheres to the installation surface of the third electrophoresis chamber, and separating the biological sample through isoelectric focusing.

56. The sample separation method according to claim 55, further comprising:
a conveyance step of conveying the sample separation medium, in which the biological sample has been separated by performing the first electrophoresis step, to a second electrophoresis chamber; and
a second electrophoresis step of applying a voltage to the sample separation medium, which has been conveyed to the second electrophoresis chamber, and separating the biological sample through SDS-polyacrylamide gel electrophoresis.

57. An electrophoresis instrument comprising:
an electrophoresis chamber that includes an installation surface on which a sample separation medium for separating a biological sample through electrophoresis is installed, and a first electrode and a second electrode that are connected to both ends of the sample separation medium;
wherein a sample holding part, which maintains a sample solution including the biological sample while suppressing wet spreading of the sample solution, is provided on the installation surface of the electrophoresis chamber.
